(19) United States
(12) Patent Application Publication
(10) Pub. No.: US 2021/0181648 A1
(43) Pub. Date: Jun. 17, 2021

(54) TONER

(71) Applicant: CANON KABUSHIKI KAISHA, Tokyo (JP)

(72) Inventors: Tsutomu Shimano, Shizuoka (JP); Takashi Matsui, Shizuoka (JP); Kenji Aoki, Shizuoka (JP); Shohei Shibahara, Shizuoka (JP); Yuna Yamamoto, Shizuoka (JP)

(21) Appl. No.: 17/117,223

(22) Filed: Dec. 10, 2020

(30) Foreign Application Priority Data
Dec. 12, 2019 (JP) 2019-224161

(51) Int. Cl. G03G 9/087; G03G 9/08; C08F 220/46

(52) U.S. Cl. CPC G03G 9/08711; C08F 220/46; G03G 9/0821

(57) ABSTRACT

A toner comprising a toner particle including a crystalline resin, wherein where a complex modulus of elasticity at 30° C. is denoted by G*(30) and a complex modulus of elasticity at 50° C. is denoted by G*(50) in dynamic viscoelasticity measurement of the toner, and where a peak temperature of an exothermic peak derived from the crystalline resin in a temperature lowering process after a temperature is raised to 150° C., is denoted by Tc (° C.), a peak temperature of an endothermic peak derived from the crystalline resin in a temperature raising process after the temperature lowering process, is denoted by Tm (° C.), and an endothermic quantity is denoted by ΔH (J/g) in differential scanning calorimetry of the toner, G*(30), G*(50), Tc, Tm and ΔH satisfy specific relationships.

### BACKGROUND OF THE INVENTION

### Field of the Invention

The present disclosure relates to a toner for developing an electrostatic latent image formed by a method, such as an electrophotographic method, an electrostatic recording method, or a toner jet recording method, to form a toner image.

### Description of the Related Art

In recent years, a toner having excellent low-temperature fixability has been required in order to support further power saving in printers and copiers. To meet such a requirement, a toner that melts quickly at a lower temperature, that is, a toner that has excellent sharp melt property is preferable. In order to obtain a toner having excellent sharp melt property, a toner using a crystalline resin as a binder resin has been studied.

Since crystalline resins have a property of becoming a solid due to a regular arrangement of molecules, the viscosity of the entire crystalline resins drops sharply when the resins are heated to a temperature at which this regular arrangement is loosened. As a result, a toner having excellent sharp melt property that melts quickly at a low temperature can be obtained while obtaining excellent heat-resistant storage stability.

Against this background, Japanese Patent Application Publication No. 2014-130243, Japanese Patent Application Publication No. 2014-142632, WO 2018/110593, and Japanese Patent Application Publication No. 2014-59359 each propose a toner using a binder resin including a crystalline resin.

### SUMMARY OF THE INVENTION

Meanwhile, printers and copiers are also attracting attention for applications other than office applications, and there is a strong demand for improving the quality of obtained products. In particular, heat resistance and scratch resistance of obtained products are required to exceed the conventional performance. The scratch resistance in the present disclosure means the likelihood of an image surface to be scratched or unlikelihood to be peeled off when rubbed.

A crystalline resin has excellent sharp melt property but has low elasticity, so the crystalline resin has the property of being easily cracked as a resin. As a result, a toner using a crystalline resin as a binder resin tends to have a significant potential for improvement in terms of scratch resistance of an obtained image.

Japanese Patent Application Publication No. 2014-130243 proposes a toner having a shell covering a core by using a crystalline resin as a binder resin. Further, Japanese Patent Application Publication No. 2014-142632 proposes a toner having a sea-island structure in which a sea portion including a crystalline resin as a main component and an island portion including an amorphous resin as a main component are present. Japanese Patent Application Publication No. 2014-130243 and Japanese Patent Application Publication No. 2014-142632 indicate that both low-temperature fixability and bending strength of images are achieved with the above configuration.

However, in the toners described in Japanese Patent Application Publication No. 2014-130243 and Japanese Patent Application Publication No. 2014-142632, since the crystalline resin and the amorphous resin are individually present, there is still room for further improvement of scratch resistance of images from the viewpoint of cracking ability inherent to crystalline resins and the like. Regarding this problem, the scratch resistance of images can be improved by introducing an amorphous segment into the crystalline resin and improving the elasticity of the resin. However, when the amorphous segment is introduced into the crystalline resin, the crystallization of the crystalline segment is inhibited, therefore the crystallization rate is lowered. Hence, an image after fixing cannot be sufficiently solidified, and the heat resistance of the image is lowered.

WO 2018/110593 indicates that by using as a binder resin a polymer including a (meth)acrylate having a chain hydrocarbon group having from 18 to 36 carbon atoms as an essential constituent monomer, both low-temperature fixability and storage stability are achieved. However, the monomer to be used has not been studied, in particular, from the viewpoint of the crystallization rate of the crystalline resin, and there is room for further improvement in the heat resistance of the resulting images.

Japanese Patent Application Publication No. 2014-59359 indicates that by using a binder resin including a crystalline resin and also using a nucleating agent, both low-temperature fixability and heat resistance of images are achieved. However, the crystallization rate is not sufficient, and as a result, it is necessary to further improve both low-temperature fixability and heat resistance of images from the viewpoint of the toner performance that is currently required.

For these reasons, it is difficult to achieve, at the same time, scratch resistance of images, heat resistance of images, and also low-temperature fixability in a toner using a crystalline resin as a binder resin.

This disclosure provides a toner that solves such a problem.

That is, the present disclosure provides a toner that has low-temperature fixability, heat resistance of images, and scratch resistance of images.

The present disclosure is a toner comprising a toner particle including a crystalline resin, wherein

where a complex modulus of elasticity at 30° C. is denoted by G*(30) and a complex modulus of elasticity at 50° C. is denoted by G*(50) in dynamic viscoelasticity measurement of the toner, following is satisfied:

1.00≥G*(50)/G*(30)≥0.30,
and where
   a peak temperature of an exothermic peak derived from the crystalline resin in a temperature lowering process after a temperature is raised to 150° C., is denoted by Tc (° C.),
   a peak temperature of an endothermic peak derived from the crystalline resin in a temperature raising process after the temperature lowering process, is denoted by Tm (° C.), and
   an endothermic quantity is denoted by ΔH (J/g) in differential scanning calorimetry of the toner,
Tm is 50.0 to 80.0° C.,
ΔH is 35 to 60 J/g, and
Tm−Tc is 0.0 to 7.0° C.

The present disclosure is a toner comprising a toner particle including a crystalline resin and a wax, wherein

where a complex modulus of elasticity at 30° C. is denoted by G*(30) and a complex modulus of elasticity at 50° C. is denoted by G*(50) in dynamic viscoelasticity measurement of the toner, following is satisfied:

1.00≥G*(50)/G*(30)≥0.30,

an amount of the wax in the toner particle is 1 to 20 parts by mass with respect to 100 parts by mass of the crystalline resin; and

and where
a peak temperature of a maximum exothermic peak in a temperature lowering process after a temperature is raised to 150° C., is denoted by Tc′ (° C.),
a peak temperature of a maximum endothermic peak in a temperature raising process after the temperature lowering process, is denoted by Tm′ (° C.),
and an endothermic quantity is denoted by ΔH′ (J/g) in differential scanning calorimetry of the toner,
Tm′ is 50.0 to 80.0° C.,
ΔH′ is 35 to 60 J/g, and
Tm′−Tc′ is 0.0 to 7.0° C.

According to the present disclosure, a toner that has low-temperature fixability, heat resistance of images, and scratch resistance of images can be provided.

Further features of the present invention will become apparent from the following description of exemplary embodiments.

### DESCRIPTION OF THE EMBODIMENTS

In the present disclosure, the description of “from XX to YY” or “XX to YY” indicating a numerical range means a numerical range including a lower limit and an upper limit which are end points, unless otherwise specified. In addition, the measurement method of each physical property will be described later.

When the numerical range is described step by step, the upper and lower limits of each numerical range can be arbitrarily combined.

A “monomer unit” refers to the reacted form of a monomer substance in a polymer. For example, one carbon-carbon bond section in a main chain in which a vinyl-based monomer in a polymer is polymerized is set as one unit.

A crystalline resin refers to a resin that shows a clear endothermic peak in differential scanning calorimetry.

A fist toner of the present disclosure is a toner comprising a toner particle including a crystalline resin, wherein

where a complex modulus of elasticity at 30° C. is denoted by G*(30) and a complex modulus of elasticity at 50° C. is denoted by G*(50) in dynamic viscoelasticity measurement of the toner, following is satisfied:

1.00≥G*(50)/G*(30)≥0.30,

and where
a peak temperature of an exothermic peak derived from the crystalline resin in a temperature lowering process after a temperature is raised to 150° C., is denoted by Tc (° C.),
a peak temperature of an endothermic peak derived from the crystalline resin in a temperature raising process after the temperature lowering process, is denoted by Tm (° C.), and
an endothermic quantity is denoted by ΔH (J/g) in differential scanning calorimetry of the toner,

Tm is 50.0 to 80.0° C.,

ΔH is 35 to 60 J/g, and

Tm−Tc is 0.0 to 7.0° C.

A second toner of the present disclosure is a toner comprising a toner particle including a crystalline resin and a wax, wherein

where a complex modulus of elasticity at 30° C. is denoted by G*(30) and a complex modulus of elasticity at 50° C. is denoted by G*(50) in dynamic viscoelasticity measurement of the toner, following is satisfied:

1.00≥G*(50)/G*(30)≥0.30,

an amount of the wax in the toner particle is 1 to 20 parts by mass with respect to 100 parts by mass of the crystalline resin; and

and where
a peak temperature of a maximum exothermic peak in a temperature lowering process after a temperature is raised to 150° C., is denoted by Tc′ (° C.),
a peak temperature of a maximum endothermic peak in a temperature raising process after the temperature lowering process, is denoted by Tm′ (° C.), and
an endothermic quantity is denoted by ΔH′ (J/g) in differential scanning calorimetry of the toner,

Tm′ is 50.0 to 80.0° C.,

ΔH′ is 35 to 60 J/g, and

Tm′−Tc′ is 0.0 to 7.0° C.

Here, since the amount of wax in a toner particle in the second toner is smaller than the amount of the crystalline resin, the peak temperature Tc′ of the maximum exothermic peak, the peak temperature Tm′ of the maximum endothermic peak, and the endothermic quantity ΔH′ are handled as being derived from a crystalline resin.

In the differential scanning calorimetry of the toner (hereinafter, also simply referred to as DSC measurement), where the peak temperature of the exothermic peak derived from the crystalline resin in the temperature lowering process after raising the temperature to 150° C. is denoted by Tc, and the peak temperature of the endothermic peak derived from the crystalline resin in the temperature raising process after the temperature lowering process is denoted by Tm, the difference Tm−Tc between Tm and Tc is used as a crystallization rate index. Further, the endothermic quantity derived from the crystalline resin in the temperature raising process after the temperature lowering process is defined as ΔH.

Here, Tm indicates the melting point of the crystalline resin, and Tc indicates the crystallization temperature of the crystalline resin.

Tc, Tm, and ΔH derived from the crystalline resin can be specified when no wax is contained in the toner particle, or when the peak temperature of the exothermic peak derived from the crystalline resin, the peak temperature of the endothermic peak derived from the crystalline resin, and the endothermic quantity derived from the crystalline resin are significantly different from the peak temperature of the exothermic peak derived from the wax, the peak temperature of the endothermic peak derived from the wax, and the endothermic quantity derived from the wax, respectively.

However, where the peak temperature of the exothermic peak derived from the crystalline resin, the peak temperature of the endothermic peak derived from the crystalline resin, and the endothermic quantity derived from the crystalline resin are close to the peak temperature of the exothermic peak derived from the wax, the peak temperature of the endothermic peak derived from the wax, and the endothermic quantity derived from the wax, respectively, and are difficult to distinguish therefrom, Tc′, Tm′ and ΔH′ are obtained in the following manner.

When the amount of the wax in the toner particle is from 1 part by mass to 20 parts by mass with respect to 100 parts by mass of the crystalline resin, the peak temperature of the maximum exothermic peak in the temperature lowering process after the temperature is raised to 150 C° in the DSC measurement of the toner is denoted by Tc′, the peak temperature of the maximum endothermic peak in the temperature raising process after the temperature lowering process is denoted by Tm′, and the endothermic quantity is denoted by ΔH′.

The slower the crystallization rate of a crystalline resin, the lower the crystallization temperature because crystal nuclei are not generated unless the resin is cooled to a lower temperature. As a result, the value of Tm−Tc or Tm′−Tc′ tends to increase.

For example, when the crystalline resin in the binder resin has a crystalline segment and an amorphous segment, the crystallinity rate decreases as the amount of the amorphous segment in the crystalline resin increases, so that the value of Tm−Tc or Tm′−Tc′ tends to increase.

Meanwhile, the higher the amount of the crystalline segment in the crystalline resin, the faster the crystallization rate, so that the value of Tm−Tc or Tm′−Tc′ tends to decrease. The smaller the value of Tm−Tc or Tm′−Tc′, the faster the image after fixing is solidified, so that excellent heat resistance of the image tends to be obtained.

There are various means to achieve the above physical properties. For example, in the case of a toner including a crystalline resin having a crystalline segment and an amorphous segment in a binder resin, the heat resistance of an image is increased by lowering the glass transition temperature (hereinafter, simply referred to as Tg) of the crystalline resin. The properties are improved, and compatibility with other properties is better achieved.

In general, the lower the Tg of the binder resin, the softer the toner at a lower temperature, so the heat resistance of the toner and the image decreases. However, it was found that in a toner including a crystalline resin having a crystalline segment and an amorphous segment in the binder resin, the lower the Tg of the crystalline resin, the higher the crystallization rate of the crystalline resin (the value of Tm−Tc or Tm′−Tc′ tends to be smaller). This is apparently because when the Tg of the crystalline resin is higher than the temperature at which the crystalline resin crystallizes, the molecular motion of the crystalline resin is constrained by the amorphous segment and the crystallization rate is reduced.

As a result, it can be seen that in a toner using a crystalline resin as a binder resin, the lower the Tg of the crystalline resin, the higher the heat resistance of images tends to be.

Meanwhile, when G*(50)/G*(30) is from 0.30 to 1.00, it means that the change in elastic modulus at the storage temperature of images is small. In order to achieve this, for example, Tm or Tm′ is set to from 50.0° C. to 80.0° C., and at the same time, the Tg of the crystalline resin is raised to some extent.

The toner of the present disclosure satisfies the following formula where the complex modulus of elasticity at 30° C. is G*(30) and the complex modulus of elasticity at 50° C. is G*(50) in the dynamic viscoelasticity measurement of the toner.

1.00≥G*(50)/G*(30)≥0.30

Here, G*(50)/G*(30) is used as an index of heat resistance of images. A large value of G*(50)/G*(30) means that the change in complex modulus of elasticity from 30° C. to 50° C. is small and the hardness of the toner can be maintained.

Where G*(50)/G*(30) is 0.30 or more, excellent heat resistance of images can be obtained. G*(50)/G*(30) is preferably from 0.40 to 1.00, and more preferably from 0.50 to 1.00.

G*(50)/G*(30) can be controlled by changing Tm or Tm′, or Tg of the crystalline resin, or by using a monomer capable of forming an amorphous segment for the crystalline resin

In the toner of the present disclosure, Tm or Tm′ is from 50.0° C. to 80.0° C.

When Tm or Tm′ is 50° C. or higher, excellent heat resistance of images can be obtained. Further, when Tm or Tm′ is 80.0° C. or lower, excellent low-temperature fixability can be obtained. Tm or Tm′ is preferably from 50.0° C. to 75.0° C., and more preferably from 50.0° C. to 70.0° C. Tm or Tm′ can be controlled by the type and content ratio of the monomer used in the crystalline resin.

The toner of the present disclosure has ΔH or ΔH′ of from 35 J/g to 60 J/g. When ΔH or ΔH′ is 35 J/g or more, excellent low-temperature fixability can be obtained. When ΔH or ΔH′ is 60 J/g or less, excellent scratch resistance of image can be obtained. The ΔH or ΔH′ is preferably from 35 J/g to 55 J/g, and more preferably from 35 J/g to 50 J/g.

ΔH or ΔH′ can be controlled by the amount of the crystalline resin in the toner particle, the type and content ratio of the monomer used in the crystalline resin, and the like.

Tm−Tc or Tm′−Tc′ of the toner of the present disclosure is from 0.0° C. to 7.0° C. When Tm−Tc or Tm′−Tc′ is within this range, excellent heat resistance of images can be obtained. Tm−Tc or Tm′−Tc′ is preferably from 0.0° C. to 6.5° C., and more preferably from 0.0° C. to 6.0° C.

Tm−Tc or Tm′−Tc′ can be controlled by the amount of the crystalline resin in the toner particle, the composition and physical properties of components other than the crystalline resin, the Tg of the crystalline resin, and the like.

Further, as will be described later, the type of monomer used for the crystalline resin is selected from the viewpoint of the SP value and Q value of each monomer, and the design can be made such that Tm−Tc or Tm′−Tc′ of the crystalline resin has the desired value.

Further, the toner of the present disclosure preferably has a Tc or Tc′ of from 40.0° C. to 80.0° C., and more preferably from 48.0° C. to 75.0° C. When Tc or Tc′ is within the above range, the crystallinity of the obtained image can be sufficiently increased, so that excellent heat resistance of images can be obtained. Tc or Tc′ can be controlled by the amount of the crystalline resin in the toner particles, the composition and physical properties of components other than the crystalline resin, the Tg of the crystalline resin, and the like.

A toner that achieves all of these physical properties at the same time is unknown in the art, and more favorable physical properties can be achieved by introducing an idea that is contrary to the conventional approach of lowering the Tg of crystalline resin.

The following embodiment of the toner of the present disclosure is preferable.

The crystalline resin comprises a monomer unit derived from a monomer (a),

the monomer (a) is a (meth)acrylate having a chain hydrocarbon group having from 18 to 36 carbon atoms, and

a content ratio N(a) of the monomer unit derived from the monomer (a) in the crystalline resin is from 30% by mass to 60% by mass.

The crystalline resin having a monomer unit derived from a (meth)acrylate having a chain hydrocarbon group having from 18 to 36 carbon atoms is a side-chain crystalline resin in which the chain hydrocarbon group portion, which is a side chain, is crystallized. Therefore, the crystallization rate is faster than that of a foldable-crystal-type crystalline resin such as a crystalline polyester. As a result, better heat resistance of image can be obtained.

When the content ratio N(a) of the monomer unit derived from the monomer (a) in the crystalline resin is 30% by mass or more, the sharp melt property is excellent and good low-temperature fixability can be obtained. Further, when the content ratio is 60% by mass or less, a toner having excellent scratch resistance of image can be obtained. The content ratio N(a) of the monomer unit derived from the monomer (a) is more preferably from 30% by mass to 50% by mass.

Examples of the (meth)acrylate having an alkyl group having from 18 to 36 carbon atoms include (meth)acrylic acid esters having a linear alkyl group having from 18 to 36 carbon atoms [stearyl (meth)acrylate, nonadecyl (meth)acrylate, eikosyl (meth)acrylate, heneikosanyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, and the like] and (meth)acrylic acid esters having a branched alkyl group having from 18 to 36 carbon atoms [2-decyltetradecyl (meth)acrylate, and the like].

Of these, at least one selected from the group consisting of (meth)acrylates having a linear alkyl group having from 18 to 36 carbon atoms is preferable from the viewpoint of heat-resistant storage and low-temperature fixability of images, at least one selected from the group consisting of (meth)acrylates having a linear alkyl group having from 18 to 30 carbon atoms is more preferable, and at least one selected from the group composed of stearyl (meth)acrylate and behenyl (meth)acrylate is even more preferable.

The toner particle may include a well-known resin other than the crystalline resin as a binder resin, but the amount of the crystalline resin in the toner particle is preferably from 60% by mass to 100% by mass. When this amount is 60% by mass or more, the characteristics of the toner using the crystalline resin as the binder resin can be obtained, so that even better low-temperature fixability and heat resistance of images can be obtained. The amount of the crystalline resin in the toner particle is more preferably from 65% by mass to 90% by mass.

As a resin other than the crystalline resin, a resin conventionally used for toners can be used as the binder resin. Examples thereof include polyester resin, styrene acrylic resin, polyamide resin, furan resin, epoxy resin, xylene resin, silicone resin and the like.

The glass transition temperature of the crystalline resin is preferably from 50° C. to 90° C. When the glass transition temperature of the crystalline resin is 50° C. or higher, the resin is unlikely to soften even at the storage temperature, so that even better heat resistance of images can be obtained. Further, when the glass transition temperature of the crystalline resin is 90° C. or lower, the crystallization rate of the crystalline resin is improved, so that the value of Tm−Tc or Tm′−Tc′ can be reduced. As a result, better heat resistance of images can be obtained.

The glass transition temperature is preferably from 60° C. to 85° C., and more preferably from 65° C. to 80° C. The glass transition temperature can be controlled by the type and content ratio of the monomers used in the crystalline resin.

The following embodiment of the toner of the present disclosure is also preferable.

The crystalline resin further comprises a monomer unit derived from a monomer (b),

where an SP value of the monomer unit derived from the monomer (a) is denoted by SP(a) (J/cm³)^{0.5}, and an SP value of the monomer unit derived from the monomer (b) is denoted by SP(b) (J/cm³)^{0.5}, following is satisfied:

SP(b)−SP(a)≥4.0,

and a content ratio N(b) of the monomer unit derived from the monomer (b) in all the monomer units other than the monomer unit derived from the monomer (a) in the crystalline resin is from 50% by mass to 100% by mass.

Satisfying SP(b)−SP(a)≥4.0 means that the polarities of the monomer unit derived from the monomer (a) and the monomer unit derived from the monomer (b) are separated. Since the polarities of the monomer unit derived from the monomer (a) and the monomer unit derived from the monomer (b) are separated, the monomer unit derived from the monomer (a) and the monomer unit derived from the monomer (b) are less likely to be mixed, and these monomer units are present in a microphase-separated state in the crystalline resin.

As a result, the concentration of the monomer unit derived from the monomer (a) is locally increased, and the crystallization rate of the crystalline resin is improved, so that better heat resistance of images can be obtained. SP(b)−SP(a) is preferably 5.0 or more, and more preferably 6.0 or more.

Further, when N(b) is 50% by mass or more, the above-mentioned effect is further enhanced, and more excellent heat resistance of the image can be obtained. N(b) is more preferably 50.0% by mass or more and 85.0% by mass or less.

SP(a) and SP(b) are determined by the molecular structure of the monomer (a) and the monomer (b).

SP(a) is preferably from 17.5 (J/cm³)^{0.5} to 19.0 (J/cm³)^{0.5}, and more preferably from 18.0 (J/cm³)^{0.5} to 18.5 (J/cm³)^{0.5}.

SP(b) is preferably from 22.0 (J/cm³)^{0.5} to 29.5 (J/cm³)^{0.5}, and more preferably from 24.0 (J/cm³)^{0.5} to 26.5 (J/cm³)^{0.5}.

When there is a plurality of types of monomers satisfying the requirement of the monomer (a) in the crystalline resin, the value of SP(a) is the weighted average of the SP values of the monomer units.

For example, in the case where a monomer unit derived from a monomer (a) having an SP value of SP₁(a) is contained in A mol % based on the number of moles of all the monomer units satisfying the requirement of the monomer unit derived from the monomer (a), and a monomer unit derived from a monomer (a) having an SP value of SP₂(a) is contained in (100-A) mol % based on the number of moles of all the monomer units satisfying the requirement of the monomer unit derived from the monomer (a), SP(a) is

SP(a)=(SP₁(a)×A+SP₂(a)×(100−A))/100.

A similar calculation is performed when three or more monomer units satisfying the requirements for the monomer unit derived from the monomer (a) are included.

Meanwhile, the monomer (b) corresponds to all the monomer units satisfying

SP(b)−SP(a)≥4.0

relative to SP(a) calculated by the above method.

That is, when a plurality of types of the monomer (b) is present, SP(b) represents the SP value of the monomer unit derived from each monomer, and SP(b)−SP(a) is determined for the monomer unit derived from each monomer (b). The monomer (b) is not limited as long as the condition of SP(b)−SP(a) is satisfied, but for example, a monomer satisfying the condition of SP(b)−SP(a) can be selected for use from among the following monomers. The monomer (b) may be used alone or in combination of two or more types thereof.

Monomers having a nitrile group: for example, acrylonitrile, methacrylonitrile, and the like.

Monomers having a hydroxy group: for example, 2-hydroxyethyl (meth)acrylate, 2-hydroxypropyl (meth)acrylate, and the like.

Monomers having an amide group: for example, acrylamide, monomers obtained by reacting an amine having from 1 to 30 carbon atoms and a carboxylic acid having an ethylenically unsaturated bond and from 2 to 30 carbon atoms (acrylic acid, methacrylic acid, and the like) by a known method, and the like.

Monomers having a urethane group: for example, monomers obtained by reacting an alcohol having an ethylenically unsaturated bond and from 2 to 22 carbon atoms (2-hydroxyethyl methacrylate, vinyl alcohol, and the like) and an isocyanate having from 1 to 30 carbon atoms [monoisocyanate compounds (benzenesulfonyl isocyanate, tosyl isocyanate, phenyl isocyanate, p-chlorophenyl isocyanate, butyl isocyanate, hexyl isocyanate, t-butyl isocyanate, cyclohexyl isocyanate, octyl isocyanate, 2-ethylhexyl isocyanate, dodecyl isocyanate, adamantyl isocyanate, 2,6-dimethylphenyl isocyanate, 3,5-dimethylphenyl isocyanate, 2,6-dipropylphenyl isocyanate, and the like), aliphatic diisocyanate compounds (trymethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, 2,4,4-trimethylhexamethylene diisocyanate, and the like), alicyclic diisocyanate compounds (1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, hydrogenated tetramethylxylylene diisocyanate, and the like), and aromatic diisocyanate compounds (phenylenediocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, xylylene diisocyanate, and the like)] by a known method;

monomers obtained by reacting an alcohol having from 1 to 26 carbon atoms (methanol, ethanol, propanol, isopropyl alcohol, butanol, t-butyl alcohol, pentanol, heptanol, octanol, 2-ethylhexanol, nonanol, decanol, undecyl alcohol, lauryl alcohol, dodecyl alcohol, myristyl alcohol, pentadecyl alcohol, cetanol, heptadecanol, stearyl alcohol, isostearyl alcohol, ellaidyl alcohol, oleyl alcohol, linoleil alcohol, linolenyl alcohol, nonadecil alcohol, heneicosanol, behenyl alcohol, erucyl alcohol, and the like) and an isocyanate having an ethylenically unsaturated bond and from 2 to 30 carbon atoms [2-isocyanatoethyl (meth)acrylate, 2-(0-[1′-methylpropylideneamino]carboxyamino)ethyl (meth)acrylate, 2-[(3,5-dimethylpyrazolyl)carbonylamino]ethyl (meth)acrylate, 1,1-(bis (meth)acryloyloxymethyl)ethyl isocyanate, and the like] by a known method, and

monomers having a urea group: for example, monomers obtained by reacting an amine having from 3 to 22 carbon atoms [primary amines (normal butylamine, t-butylamine, propylamine, isopropylamine, and the like), secondary amines (dinormalethylamine, dinormalpropylamine, dinormal butylamine, and the like), aniline, cycloxylamine, and the like] and an isocyanate having an ethylenically unsaturated bond and from 2 to 30 carbon atoms by a known method, and the like; and

monomer having a carboxy group: for example, methacrylic acid, acrylic acid, 2-carboxyethyl (meth)acrylate, and the like.

The following embodiment of the toner of the present disclosure is preferable as well.

The toner particle further includes an amorphous resin, and

where an SP value of the amorphous resin is denoted by SP(B) (J/cm³)^{0.5} and an SP value of the crystalline resin is denoted by SP(A) (J/cm³)^{0.5}, the following is satisfied:

3.0≥|SP(B)−SP(A)|≥0.0.

When |SP(B)−SP(A)| is 3.0 or less, the amorphous resin and the crystalline resin are easily compatible with each other. Therefore, the amorphous resin and the crystalline resin are sufficiently mixed, and the crystalline resin can be made unlikely to crack. As a result, better scratch resistance of image can be obtained.

|SP(B)−SP(A)| is preferably from 0.0 to 2.6, and more preferably from 0.0 to 2.3. Further, SP(A) is preferably 19.0 (J/cm³)^{0.5} to 26.0 (J/cm³)^{0.5}, and more preferably 20.0 (J/cm³)^{0.5} to 25.0 (J/cm³)^{0.5}.

Furthermore, SP(B) is preferably from 20.0 (J/cm³)^{0.5} to 24.0 (J/cm³)^{0.5}, and more preferably from 20.5 (J/cm³)^{0.5} to 23.0 (J/cm³)^{0.5}.

SP(A) and SP(B) can be controlled by the type and amount ratio of the monomer used in the crystalline resin and the amorphous resin.

As the amorphous resin, a resin conventionally used for toners can be used. Examples thereof include polyester resin, styrene acrylic resin, polyamide resin, furan resin, epoxy resin, xylene resin, silicone resin, and the like. Of these, styrene acrylic resin is preferable.

The amount of the amorphous resin in the toner particle is preferably from 2% by mass to 40% by mass.

The crystalline resin preferably further comprises a monomer unit derived from the monomer (c), and the Q value of the monomer (c) is smaller than the Q value of the monomer (a). Here, the Q value is a parameter proposed by Alfrey and Prince and represents the resonance stabilizing effect of a substituent in a Q-e theory dealing with the reactivity of vinyl monomers.

The Q value is a value indicating the degree of conjugation when a polymerizable monomer becomes a radical, and is a factor that correlates with the degree and speed of the reaction during copolymerization. When the Q value is large, the polymerizable monomer tends to become a radical, but the radical polymerization reaction tends to be slow. When the Q value is small, the polymerizable monomer is unlikely to become a radical, but the radical polymerization reaction tends to be rapid.

When the Q value of the monomer (c) is smaller than the Q value of the monomer (a), the radical polymerization reaction of the monomer (c) takes precedence over the monomer (a). Therefore, linking between the monomers (c) and linking between the monomers (a) are more likely to occur than linking between the monomer (c) and the monomer (a). As a result, the concentration of the monomer unit derived from the monomer (a) in the crystalline resin is locally increased, and the crystallization rate of the crystalline resin is improved. Therefore, better heat resistance of the image can be obtained.

The Q values of many polymerizable monomers are published in a “POLYMER HANDBOOK (published by Wiley-Interscience)”. For polymerizable monomers not listed in the “POLYMER HANDBOOK (published by Wiley-Interscience)”, the Q value can be determined by the method described on page 267 of the “POLYMER HANDBOOK (published by Wiley-Interscience)”.

Further, where the Q value of the monomer (c) is denoted by Q(c) and the Q value of the monomer (a) is denoted by Q(a), it is preferable that Q(a)-Q(c) be from 0.210 to 0.230, and more preferably from 0.210 to 0.223.

Further, Q(c) is preferably from 0.025 to 0.040, and more preferably from 0.027 to 0.040. Furthermore, Q(a) is preferably from 0.20 to 0.30. When there is a plurality of types of monomers satisfying the requirement of the monomer (a) in the crystalline resin, the value of Q(a) is the weighted average of the Q values of the monomer units.

For example, in the case where a monomer unit derived from a monomer (a) having a Q value of Q₁(a) is contained in A mol % based on the number of moles of all the monomer units satisfying the requirement of the monomer unit derived from the monomer (a), and a monomer unit derived from a monomer (a) having an Q value of Q₂(a) is contained in (100-A) mol % based on the number of moles of all the monomer units satisfying the requirement of the monomer unit derived from the monomer (a), Q(a) is

Q(a)=(Q₁(a)×A+Q₂(a)×(100−A))/100.

A similar calculation is performed when three or more monomer units satisfying the requirements for the monomer unit derived from the monomer (a) are included. Q(c) is also calculated in the same manner.

Further, a content ratio N(c) of the monomer unit derived from the monomer (c) in all the monomer units other than the monomer unit derived from the monomer (a) in the crystalline resin is from 20% by mass to 100% by mass.

When N(c) is 20% by mass or more, the crystallization rate of the crystalline resin is further improved, so that more excellent heat resistance of the image can be obtained. N(c) is more preferably 30% by mass or more, and further preferably 50% by mass or more.

When a plurality of monomers satisfying the condition of the monomer (c) is contained, N(c) is calculated based on the total amount of all the monomers satisfying the condition of the monomer (c).

Examples of the monomer that can be used as the monomer (c) include vinyl acetate, vinyl benzoate, vinyl pivalate, vinyl propionate, vinyl butyrate, tert-butyl vinyl benzoate, vinyl chloroacetate, vinyl decanoate, vinyl n-octanoate, vinyl hexanoate, vinyl chlorobenzoate, vinyl methacrylate, vinyl palmitate, vinyl stearate, vinyl trifluoroacetate, vinyl octylate, vinyl caprylate, vinyl laurate, vinyl myristate, vinyl caproate, and the like.

Among these, it is more preferable that the monomer (c) has the structure represented by the following formula (1).

R—COO—CH═CH₂ (1)

In the formula, R represents a phenyl group or an alkyl group having from 1 to 12 (preferably from 1 to 4) carbon atoms.

Further, it is more preferable that the monomer (c) is at least one selected from the group consisting of vinyl benzoate, vinyl pivalate and vinyl propionate.

When the monomer (c) has these structures, the effect due to the easy linking of the monomer (b) described hereinbelow can be obtained. As a result, higher heat resistance of the image is obtained.

Further, the crystalline resin may include vinyl acetate or may not include vinyl acetate.

Regarding the monomer (c), where the SP value of a monomer unit derived from the monomer (c) is denoted by SP(c) (J/cm³)⁵, it is preferable that following is satisfied:

SP(c)−SP(a)≤4.0.

Satisfying SP(c)−SP(a)≤4.0 means that the polarities of the monomer (a) and the monomer (c) are close to each other. When using the monomer (c) close in polarity to the monomer (a), the segment derived from the monomer (a) in the crystalline resin and the segment derived from the monomer (c) in the amorphous resin are less likely to be mixed. As a result, cracking resistance of the crystalline resin can be improved, and better scratch resistance of images can be obtained. SP(c)−SP(a) is more preferably 3.5 or less. SP(c)−SP(a) is preferably 0.0 or more, and more preferably 0.5 or more.

SP(c) is preferably from 18.5 (J/cm³)^{0.5} to 22.5 (J/cm³)^{0.5}, and more preferably from 19.0 (J/cm³)^{0.5} to 22.2 (J/cm³)^{0.5}.

When there is a plurality of types of monomers satisfying the requirement of the monomer (c) in the crystalline resin, the value of SP(c) is the weighted average of the SP values of the monomer units.

For example, in the case where a monomer unit derived from a monomer (c) having an SP value of SP₁(c) is contained in A mol % based on the number of moles of all the monomer units satisfying the requirement of the monomer unit derived from the monomer (c), and a monomer unit derived from a monomer (c) having an SP value of SP₂(c) is contained in (100−A) mol % based on the number of moles of all the monomer units satisfying the requirement of the monomer unit derived from the monomer (c), SP(c) is

SP(c)=(SP₁(c)×A+SP₂(c)×(100−A))/100.

A similar calculation is performed when three or more monomer units satisfying the requirements for the monomer unit derived from the monomer (c) are included.

It is preferable that the crystalline resin further comprises a monomer unit derived from the monomer (b), and where an SP value of the monomer unit derived from the monomer (c) is denoted by SP(c) (J/cm³)⁵, and an SP value of the monomer unit derived from the monomer (b) is denoted by SP(b) (J/cm³)^{0.5}, following is satisfied:

SP(b)−SP(c)≥3.0.

Satisfying SP(b)−SP(c)≥3.0 means that the polarities of the monomer (c) and the monomer (b) are separated. By using the monomer (b) having a polarity different from that of the monomer (c), the monomers (c) can be more easily linked to each other. Therefore, the monomers (b) can be easily linked to each other, and the crystallization rate of the crystalline resin is improved. As a result, better heat resistance of images can be obtained.

SP(b)−SP(c) is more preferably 4.0 or more. SP(b)−SP(c) is preferably 9.0 or less, and more preferably 8.0 or less. SP(c) and SP(b) are determined by the molecular structure of the monomer (c) and the monomer (b).

The monomer (b) corresponds to all the monomer units satisfying

SP(b)−SP(c)≥3.0

relative to SP(c) calculated by the above method.

That is, when a plurality of types of the monomer (b) is present, SP(b) represents the SP value of the monomer unit derived from each monomer, and SP(b)−SP(c) is determined for the monomer unit derived from each monomer (b).

Further, the crystalline resin may comprise a monomer unit derived from a monomer other than the above-mentioned monomers from (a) to (c) as long as the above-mentioned numerical ranges are not impaired.

Examples of the monomers other than the monomers from (a) to (c) include styrene and derivatives thereof such as styrene, o-methylstyrene, and the like, and (meth)acrylates such as methyl (meth)acrylate, n-butyl (meth)acrylate, t-butyl (meth)acrylate, 2-ethylhexyl (meth)acrylate, and the like.

The toner particle of the present disclosure may include wax, but the amount of wax in the toner particle is from 1 part by mass to 20 parts by mass with respect to 100 parts by mass of the crystalline resin.

Examples of wax are presented hereinbelow.

Esters of monohydric alcohols and monocarboxylic acids, such as behenyl behenate, stearyl stearate, palmityl palmitate, and the like; esters of dicarboxylic acids and monohydric alcohols, such as dibehenyl sebacate and the like; esters of dihydric alcohols and monocarboxylic acids, such as ethylene glycol distearate, hexanediol dibehenate, and the like; esters of trihydric alcohols and monocarboxylic acids such as glycerin tribehenate; esters of tetrahydric alcohols and monocarboxylic acids such as pentaerythritol tetrasterate, pentaerythritol tetrapalmitate, and the like; esters of hexahydric alcohols and monocarboxykic acids, such as dipentaerythritol hexasterate, dipentaerythritol hexapalminate, and the like; esters of polyfunctional alcohols and monocarboxylic acids, such as polyglycerin behenate and the like; natural ester waxes such as carnauba wax, rice wax, and the like; petroleum hydrocarbon waxes such as paraffin wax, microcrystalline wax, petrolatum, and the like and derivatives thereof, hydrocarbon waxes obtained by a Fischer-Tropsch method and derivatives thereof polyolefin-based hydrocarbon waxes such as polyethylene wax, polypropylene wax, and the like, and derivatives thereof, higher aliphatic alcohols; fatty acids such as stearic acid, palmitic acid, and the like; acid amide waxes and the like.

The amount of wax in the toner may be from 5.0% by mass to 15.0% by mass, or from 5.0% by mass to 10% by mass.

The toner particle may include a colorant. Examples of the colorant include black colorants, yellow colorants, magenta colorants, and cyan colorant.

Examples of black colorants include carbon black and the like.

Examples of yellow colorants include yellow pigments represented by monoazo compounds; disazo compounds; condensed azo compounds; isoindolinone compounds; isoindoline compounds; benzimidazolone compounds; anthraquinone compounds; azo metal complexes; methine compounds; allylamide compounds, and the like. Specific examples include C.I. Pigment Yellow 74, 93, 95, 109, 111, 128, 155, 174, 180, 185, and the like.

Examples of magenta colorants include magenta pigments represented by monoazo compounds; condensed azo compounds; diketopyrrolopyrrole compounds; anthraquinone compounds; quinacridone compounds; base dye lake compounds; naphthol compounds; benzimidazolone compounds; thioindigo compounds; perylene compounds, and the like. Specific examples include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254, 269, C.I. Pigment Bio Red 19, and the like.

Examples of the cyan colorants include cyan pigments represented by copper phthalocyanine compounds and derivatives thereof, anthraquinone compounds, basic dye lake compounds, and the like. Specific examples include C.I. Pigment Blue 1, 7, 15, 15:1, 15:2, 15:3, 15:4, 60, 62, and 66.

Further, various dyes conventionally known as colorants can be used together with the pigment.

The amount of the colorant is preferably from 1.0 part by mass or more and 20.0 parts by mass or less with respect to 100 parts by mass of the binder resin.

The toner particle may include, if necessary, known materials such as a charge control agent, a charge control resin, a pigment dispersant, and the like. Further, the toner particle may have, if necessary, a known material such as an organosilicon compound, a thermosetting resin, or the like on the surface thereof.

Further, the toner particle may be used as it is for a toner, or may be used for a toner by mixing, if necessary, an external additive or the like to adhere the external additive to the toner particle surface.

Examples of the external additive include inorganic fine particles selected from the group consisting of silica fine particles, alumina fine particles, and titania fine particles, or composite oxides or the like thereof. Examples of the composite oxides include silica-aluminum fine particles, strontium titanate fine particles, and the like.

The addition amount of the external additive is preferably from 0.01 parts by mass to 8.0 parts by mass, and more preferably from 0.1 parts by mass or more and 4.0 parts by mass or less with respect to 100 parts by mass of the toner particles.

A method for producing the toner is not particularly limited, and known methods such as a suspension polymerization method, a dissolution suspension method, an emulsification and aggregation method, and a pulverization method can be used.

Methods for measuring physical properties are described hereinbelow. Method for Measuring G*(50)/G*(30) of Toner

A rotating flat plate type rheometer “ARES” (manufactured by TA INSTRUMENTS) is used as a measuring device.

A sample prepared by weighing 0.1 g of toner and press molding the toner into a disk shape with a diameter of 8.0 mm and a thickness of 1.5±0.3 mm by using a tablet molding device in an environment of room temperature (25° C.) is used as a measurement sample.

The sample is mounted on a parallel plate having a diameter of 8.0 mm, the temperature is raised from room temperature (25° C.) to 100° C. in 5 min and held for 3 min, and the sample is cooled to 25° C. over 10 min. Then, the measurement is started after holding the temperature at 25° C. for 30 min. At this time, the sample is set so that the initial normal force becomes 0. Further, as described below, in the subsequent measurement, the influence of the normal force can be canceled by setting the automatic tension adjustment (Auto Tension Adjustment ON). The measurement is performed under the following conditions.

(1) A parallel plate having a diameter of 8.0 mm is used.

### (2) Frequency (Frequency) is set to 1 Hz.

(3) The applied strain initial value (Strain) is set to 0.05%.
(4) In the temperature range of from 25° C. to 60° C., the measurement is performed at a temperature rising rate (Ramp Rate) of 2.0 [° C./min]. The measurement is performed under the following automatic adjustment mode setting conditions. The measurement is performed in the automatic strain adjustment mode (Auto Strain).
(5) The maximum strain (Max Applied Strain) is set to 20.0%.
(6) The maximum torque (Max Allowed Torque) is set to 200.0 [g cm] and the minimum torque (Min Allowed Torque) is set to 0.2 [g cm].
(7) The strain adjustment (Strain Adjustment) is set to 20.0% of Current Strain. In the measurement, an automatic tension adjustment mode (Auto Tension) is adopted.
(8) The automatic tension direction (Auto Tension Direction) is set to the compression (Compression).
(9) The initial static force (Initial Static Force) is set to 10 g, and the automatic tension sensitivity (Automatic Tension Sensitivity) is set to 10.0 g.
(10) The operating condition of automatic tension (Auto Tension) is sample modulus (Sample Modulus): 1.00×10⁶ Pa or more.

When measurements are performed at a frequency of 1 Hz under the above conditions, the complex modulus of elasticity G* at 30° C. is denoted by G*(30) and the complex modulus of elasticity G* at 50° C. is denoted by G*(50), and G*(50)/G*(30) is calculated.

Method for Measuring Tc, Tc′, Tm, Tm′ and ΔH, ΔH′

When only one exothermic peak or endothermic peak occurs, or even if a plurality of the peaks occurs, but the toner particle does not contain wax, or the amount of wax in the toner particle is less than 1 part by mass per 100 parts by mass of the crystalline resin, Tc, Tm and ΔH can be measured by the following methods.

Tc, Tc′, Tm, Tm′ and ΔH, ΔH′ are measured using a differential scanning calorimetry device “Q1000” (manufactured by TA Instruments). The melting points of indium and zinc are used for temperature correction of the device detector, and the heat of fusion of indium is used for the correction of calorific value.

Specifically, 1 mg of toner is precisely weighed and placed in an aluminum pan. An empty aluminum pan is used as a reference. The temperature is raised from 0° C. to 150° C. at a heating rate of 10° C./min and maintained at 150° C. for 5 min. Then, cooling is performed from 150° C. to 0° C. at a cooling rate of 10° C./min. Among the exothermic peaks generated in this temperature lowering process, the peak temperature of the exothermic peak derived from the crystalline resin is taken as Tc (° C.).

Subsequently, after maintaining the temperature at 0° C. for 5 min, the temperature is raised from 0° C. to 150° C. at a heating rate of 10° C./min. Among the endothermic peaks generated in the DSC curve at this time, the peak temperature at the endothermic peak derived from the crystalline resin is taken as Tm (° C.), and the endothermic quantity is taken as ΔH (J/g).

In the case where there is a plurality of exothermic peaks and endothermic peaks, and the peak derived from the crystalline resin and the peak derived from the wax cannot be distinguished, this being the case where the amount of the wax in the toner particle is from 1 part by mass to 20 parts by mass per 100 parts by mass of the crystalline resin, the maximum exothermic peak and the maximum endothermic peak measured by the following methods are taken as Tc′ and Tm′, respectively.

The Tc′, Tm′ and the endothermic quantity ΔH′ are measured using a differential scanning calorimetry device “Q1000” (manufactured by TA Instruments). The melting points of indium and zinc are used for temperature correction of the device detector, and the heat of fusion of indium is used for the correction of heat quantity.

Specifically, 1 mg of toner is precisely weighed and placed in an aluminum pan. An empty aluminum pan is used as a reference. The temperature is raised from 0° C. to 150° C. at a heating rate of 10° C./min and maintained at 150° C. for 5 min. Then, cooling is performed from 150° C. to 0° C. at a cooling rate of 10° C./min. Among the exothermic peaks generated in this temperature lowering process, the peak temperature of the exothermic peak having the largest exothermic quantity is Tc′ (° C.).

Subsequently, after maintaining the temperature at 0° C. for 5 min, the temperature is raised from 0° C. to 150° C. at a heating rate of 10° C./min. Among the endothermic peaks generated in the DSC curve at this time, the peak temperature at the endothermic peak having the largest endothermic quantity is taken as Tm′ (° C.), and the endothermic quantity is taken as ΔH′ (J/g).

Method for Measuring Glass Transition Temperature of Crystalline Resin

The glass transition temperature (Tg) of the crystalline resin is measured using a differential scanning calorimetry device “Q1000” (manufactured by TA Instruments). The melting points of indium and zinc are used for temperature correction of the device detector, and the heat of fusion of indium is used for the correction of heat quantity.

Specifically, 1 mg of crystalline resin is precisely weighed and placed in an aluminum pan. An empty aluminum pan is used as a reference. Using a modulation measurement mode, the measurement is performed in the range of from 0° C. to 120° C. at a heating rate of 1° C./min and a temperature modulation condition of 0.6° C./60 sec. Since the specific heat change is obtained in the heating process, the intersection of the line at a midpoint of a baseline before and after the specific heat change appears and a differential thermal curve is taken as the glass transition temperature (Tg).

When the endothermic peaks of crystalline resin, wax, and the like overlap in the temperature range where the specific heat change occurs, the specific heat change occurs before and after the endothermic peak. In such a case, the intersection of a straight line connecting the endothermic start temperature (onset temperature) and the endothermic end temperature (offset temperature) of the endothermic peak and a line of the midpoint between the baseline before and after the specific heat change appears is taken as the glass transition temperature (Tg).

Method for Identifying Monomer (a), Monomer (b), and Monomer (c) of Crystalline Resin, and Method for Measuring Content Proportion of Monomer Unit Derived from Each Monomer The identification of various monomers in the crystalline resin and the measurement of the content ratio of the monomer unit derived from each monomer are carried out by ¹H-NMR under the following conditions.

Measuring device: FT NMR device JNM-EX400 (manufactured by JEOL Ltd.)
Measurement frequency: 400 MHz
Pulse condition: 5.0 μs
Frequency range: 10,500 Hz
Accumulation number: 64 times
Measurement temperature: 30° C.
Sample: prepared by placing 50 mg of crystalline resin as a measurement sample in a sample tube having an inner diameter of 5 mm, adding deuterated chloroform (CDCl₃) as a solvent, and dissolving in a constant temperature bath at 40° C.

From among the peaks attributed to the components of the monomer unit derived from the monomer (a) in the obtained ¹H-NMR chart, a peak independent of the peaks attributed to the components of the monomer units derived from other monomers is selected, and the integrated value S1 of this peak is calculated.

Similarly, from among the peaks attributed to the components of the monomer unit derived from the monomer (b), a peak independent of the peaks attributed to the components of the monomer units derived from other monomers is selected, and the integrated value S2 of this peak is calculated.

Furthermore, similarly, from among the peaks attributed to the components of the monomer units derived from the monomer (c) and other monomers, peaks independent of the peaks attributed to the components of the monomer units derived from other monomers are selected, and the integrated values (S3 and Sx, respectively) of these peak are calculated.

The content ratio of the monomer unit derived from the monomer (a) is determined in the following manner by using the integrated values S1, S2, S3 and Sx. Here, n1, n2, n3, and nx are each the number of hydrogen atoms in the component to which the peak observed in the respective segment is attributed.

Content proportion (mol %) of monomer unit derived from monomer (a)={(S1/n1)/((S1/n1)+(S2/n2)+(S3/n3)+(Sx/nx))}×100

Similarly, the content ratios of the monomer units derived from the monomer (b) and monomer (c) are determined as follows.

Content proportion (mol %) of monomer unit derived from monomer (b)={(S2/n2)/((S1/n)+(S2/n2)+(S3/n3)+(Sx/nx))}×100.

Content proportion (mol %) of monomer unit derived from monomer (c)={(S3/n3)/((S1/n1)+(S2/n2)+(S3/n3)+(Sx/nx))}×100.

When a monomer containing no hydrogen atom is used for a component other than the vinyl group in the crystalline resin, ¹³C-NMR is used, the measurement nucleus is set to ¹³C, the measurement is performed in a single pulse mode, and the calculation is performed in the same manner as in ¹H-NMR.

Further, when the toner is produced by the suspension polymerization method, the peaks of a release agent and other resins may overlap and independent peaks may not be observed. As a result, the content ratio of the monomer units derived from various monomers in the crystalline resin may not be calculated. In that case, the crystalline resin′ can be produced by performing the same suspension polymerization without using a release agent or other resin, and the analysis can be performed by considering the crystalline resin′ as the crystalline resin.

Method for Calculating SP Values of Units Derived from Monomer (a), Monomer (b), and Monomer (c) (SP(a), SP(b), and SP(c), Respectively)

The SP value (SP(a), SP(b), SP(c)) of each monomer is obtained in the following manner according to the calculation method proposed by Fedors.

The evaporation energy (Δei) (cal/mol) and molar volume (Δvi) (cm³/mol) are obtained from the tables described in “Polym. Eng. Sci., 14 (2), 147-154 (1974)” for an atom or atomic group having a molecular structure in which the double bond of each monomer is cleaved by polymerization, and (4.184×ΣΔei/ΣΔvi)^{0.5} is taken as the SP value (J/cm³)^{0.5}.

Method for Calculating SP Values SP(A) and SP(B) of Crystalline Resin and Amorphous Resin

The evaporation energy (Δei) and molar volume (Δvi) of the monomer units constituting the resin are determined for each monomer unit, products thereof with the molar ratio (j) of each monomer unit in the resin are calculated, and the SP value (SP(A)) of the crystalline resin is calculated from the following formula.

SP(A)={(Σj×ΣΔei)/(Σj×ΣΔvi)}^{1/2} Formula:

The SP value (SP(B)) of the amorphous resin is also calculated in the same manner.

The unit of SP value in this disclosure is (J/cm³)^{0.5}, but can be converted to (cal/cm³)^{0.5} by

1(cal/cm³)^{0.5}=2.046×10⁻³ (J/cm³)^{0.5}.

Method for Measuring Acid Value of Resin

The acid value is the weight (mg) of potassium hydroxide required to neutralize an acid contained in 1 g of a sample. The acid value of each resin in the present disclosure is measured according to JIS K 0070-1992, but specifically, it is measured according to the following procedure.

### (1) Preparation of Reagents

A total of 1.0 g of phenolphthalein is dissolved in 90 mL of ethyl alcohol (95% by volume), and ion-exchanged water is added to make 100 mL to obtain a phenolphthalein solution.

A total of 7 g of special grade potassium hydroxide is dissolved in 5 mL of water, and ethyl alcohol (95% by volume) is added to make 1 L. The solution is put in an alkali-resistant container so as to avoid contact with carbon dioxide and the like, allowed to stand for 3 days, and then filtered to obtain a potassium hydroxide solution. The obtained potassium hydroxide solution is stored in an alkali-resistant container. A total of 25 mL of 0.1 mol/L hydrochloric acid is placed in an Erlenmeyer flask, several drops of the phenolphthaline solution are added, titration is performed with the aqueous potassium hydroxide solution, and the factor of the potassium hydroxide solution is determined from the amount of the potassium hydroxide solution required for neutralization. The 0.1 mol/L hydrochloric acid used hereinabove is prepared according to JIS K 8001-1998.

### (2) Operation

### (A) Main Test

A total of 2.0 g of each pulverized resin sample is weighted into a 200 mL Erlenmeyer flask, add 100 mL of a mixed solution of toluene/ethanol (2:1) is added to dissolve the sample over 5 h. Then, a few drops of the phenolphthalein solution as an indicator are added, and titration is performed using the potassium hydroxide solution. The end point of the titration is when the light red color of the indicator continues for 30 sec.

### (B) Blank Test

The same titration as in the above operation is performed except that no sample is used (that is, only a mixed solution of toluene/ethanol (2:1) is used).

(3) Substitute the obtained result into the following formula to calculate the acid value.

A=[(C−B)×f×5.61]/S

Here, A: acid value (mg KOH/g), B: addition amount of potassium hydroxide solution in the blank test (mL), C: addition amount of potassium hydroxide solution in the main test (mL), f: factor of potassium hydroxide solution, and S: mass (g) of the sample.

Method for Measuring Weight Average Molecular Weight Mw of Resin

The weight average molecular weight (Mw) of each resin is measured by gel permeation chromatography (GPC) in the following manner.

First, the sample is dissolved in tetrahydrofuran (THF) at room temperature for 24 h. Then, the obtained solution is filtered through a solvent-resistant membrane filter “Myshori Disc” (manufactured by Tosoh Corporation) having a pore diameter of 0.2 μm to obtain a sample solution. The sample solution is adjusted so that the concentration of the component soluble in THE is 0.8% by mass. This sample solution is used for measurement under the following conditions.

Equipment: HLC8120 GPC (detector: RI) (manufactured by Tosoh)

Column: seven types, Shodex KF-801, 802, 803, 804, 805, 806, and 807 (manufactured by Showa Denko KK)

Eluent: tetrahydrofuran (THF)

Flow velocity: 1.0 mL/min

Oven temperature: 40.0° C.

Sample injection amount: 0.10 mL

In calculating the molecular weight of the sample, a molecular weight calibration curve created using standard polystyrene resins (for example, trade names “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation) is used.

### EXAMPLES

The present disclosure will be specifically described below with reference to examples, but the present disclosure is not limited to these examples. In the examples, the parts are based on mass unless otherwise specified. The unit of each SP value in the table is (J/cm³)^{0.5}.

### Production Example of Amorphous Resin 1

The following materials were added to an autoclave equipped with a decompression device, a water separator, a nitrogen gas introduction device, a temperature measuring device, and a stirrer.

| | | |
|---|---|---|
| Terephthalic acid | 32.3 | parts (50.0 mol %) |
| Bisphenol A - propylene oxide 2 mol adduct | 67.7 | parts (50.0 mol %) |
| Potassium oxalate (catalyst) | 0.02 | parts |

Subsequently, the reaction was carried out under a nitrogen atmosphere at 220° C. under normal pressure until the desired molecular weight was reached. After the temperature was lowered, the mixture was pulverized to obtain an amorphous resin 1.

The weight average molecular weight (Mw) of the obtained amorphous resin 1 was 20,000, the glass transition temperature (Tg) was 70° C., and the acid value was 5.1 mg KOH/g. Further, the SP value (SP(B)) of the amorphous resin 1 was 22.3 (J/cm³)^{0.5}.

### Production Example of Amorphous Resin 2

The following materials were put into a reaction vessel equipped with a reflux condenser, a stirrer, a thermometer, and a nitrogen introduction tube under a nitrogen atmosphere.

| | | |
|---|---|---|
| Solvent: toluene | 100.0 | parts |
| Styrene | 50.0 | parts |
| Methacrylic acid | 3.3 | parts |
| 2-Hydroxyethyl methacrylate | 46.7 | parts |
| Polymerization initiator: t-butyl peroxypivalate | 4.0 | parts |
| (Perbutyl PV, manufactured by NOF Corporation | | |

The components inside the reaction vessel were stirred at 200 rpm and heated to 70° C. to carry out a polymerization reaction for 12 h to obtain a solution in which the polymer of the monomer composition was dissolved in toluene. Subsequently, after the temperature of the solution was lowered to 25° C., the solution was poured into 1000.0 parts of methanol under stirring to precipitate methanol insolubles. The obtained methanol insolubles were filtered off, washed with methanol, and then vacuum dried at 40° C. for 24 h to obtain an amorphous resin 2. The weight average molecular weight (Mw) of the obtained amorphous resin 2 was 22,000, the glass transition temperature (Tg) was 75° C., and the acid value was 21.1 mg KOH/g. The SP value (SP(B)) of the amorphous resin 2 was 21.6 (J/cm³)^{0.5}.

### Production Example of Amorphous Resin 3

The following materials were put into a reaction vessel equipped with a reflux condenser, a stirrer, a thermometer, and a nitrogen introduction tube under a nitrogen atmosphere.

| | | |
|---|---|---|
| Solvent: toluene | 100.0 | parts |
| Styrene | 91.7 | parts |
| Methyl methacrylate | 2.5 | parts |
| Methacrylic acid | 3.3 | parts |
| 2-Hydroxyethyl methacrylate | 2.5 | parts |
| Polymerization initiator: t-butyl peroxypivalate | 4.0 | parts |
| (Perbutyl PV, manufactured by NOF Corporation | | |

The components inside the reaction vessel were stirred at 200 rpm and heated to 70° C. to carry out a polymerization reaction for 12 h to obtain a solution in which the polymer of the monomer composition was dissolved in toluene. Subsequently, after the temperature of the solution was lowered to 25° C., the solution was poured into 1000.0 parts of methanol under stirring to precipitate methanol insolubles. The obtained methanol insolubles were filtered off, washed with methanol, and then vacuum dried at 40° C. for 24 h to obtain an amorphous resin 3. The weight average molecular weight (Mw) of the obtained amorphous resin 3 was 20,000, the glass transition temperature (Tg) was 93° C., and the acid value was 21.3 mg KOH/g. The SP value (SP(B)) of the amorphous resin 3 was 20.3 (J/cm³)^{0.5}.

### Production Example of Amorphous Resin 4

The following materials were added to an autoclave equipped with a decompression device, a water separator, a nitrogen gas introduction device, a temperature measuring device, and a stirrer.

| | | |
|---|---|---|
| Terephthalic acid | 32.3 | parts (50.0 mol %) |
| Bisphenol A - propylene oxide 2 mol adduct | 67.7 | parts (50.0 mol %) |
| Trimellitic acid | 1.5 | parts |
| Potassium oxalate (catalyst) | 0.03 | parts |

Subsequently, the reaction was carried out under a nitrogen atmosphere at 220° C. under normal pressure until the desired molecular weight was reached. After the temperature was lowered, the mixture was pulverized to obtain an amorphous resin 4.

The weight average molecular weight (Mw) of the obtained amorphous resin 4 was 80,000, the glass transition temperature (Tg) was 74° C., and the acid value was 10.1 mg KOH/g. Further, the SP value (SP(B)) of the amorphous resin 4 was 22.3 (J/cm³)^{0.5}.

### Production Example of Crystalline Resin 1

The following materials were put into a reaction vessel equipped with a reflux condenser, a stirrer, a thermometer, and a nitrogen introduction tube under a nitrogen atmosphere.

| | |
|---|---|
| Solvent: toluene | 100.0 parts |
| Monomer composition | 100.0 parts |

(the monomer composition was obtained by mixing the following behenyl acrylate (monomer unit SP value: 18.3, monomer SP value: 17.7), methacrylnitrile (monomer unit SP value: 26.0, monomer SP value: 22.0), and n-butyl acrylate (monomer unit SP value: 20.0, monomer SP value: 18.0) at the ratios shown below)

| | | |
|---|---|---|
| Behenyl acrylate (22 carbon atoms) | 60.0 | parts (22.4 mol %) |
| Methacrylonitrile | 33.0 | parts (69.8 mol %) |
| n-Butyl acrylate | 7.0 | parts (7.8 mol %) |
| Polymerization initiator: t-butyl | 0.5 | parts |
| peroxypivalate (Perbutyl PV, manufactured | | |
| by NOF Corporation | | |

The components inside the reaction vessel were stirred at 200 rpm and heated to 70° C. to carry out a polymerization reaction for 12 h to obtain a solution in which the polymer of the monomer composition was dissolved in toluene. Subsequently, after the temperature of the solution was lowered to 25° C., the solution was poured into 1000.0 parts of methanol under stirring to precipitate methanol insolubles. The obtained methanol insolubles were filtered off, washed with methanol, and then vacuum dried at 40° C. for 24 h to obtain a crystalline resin 1. The weight average molecular weight (Mw) of the obtained crystalline resin 1 was 54,000, the acid value was 0.0 mg KOH/g, and the melting point was 58° C. The SP value (SP(A)) of the crystalline resin 1 was 23.8 (J/cm³).

When the crystalline resin 1 was analyzed by NMR, the monomer unit derived from behenyl acrylate was included at 22.4 mol %, the monomer unit derived from methacrylnitrile was included at 69.8 mol %, and the monomer unit derived from n-butyl acrylate was included at 7.8 mol %.

### Production Example of Crystalline Resin 2

The following materials were added to an autoclave equipped with a decompression device, a water separator, a nitrogen gas introduction device, a temperature measuring device, and a stirrer.

| | | |
|---|---|---|
| Sebacic acid | 241 | parts (44.2 mol %) |
| Adipic acid | 31 | parts (8.9 mol %) |
| 1,4-Butanediol | 164 | parts (46.9 mol %) |
| Titanium dihydroxybis(triethanolaminate) | 0.75 | parts |

Subsequently, the reaction was carried out under a nitrogen atmosphere at 220° C. under normal pressure until the weight average molecular weight Mw reached 22,000. The obtained crystalline resin 2 had a melting point of 63° C. and an acid value of 6.1 mg KOH/g. The SP value (SP(A)) of the crystalline resin 2 was 20.5 (J/cm³)^{0.5}.

### Production Examples of Toners are Shown Below

### Production Example of Toner 1

A mixture composed of the following components was prepared.

| | | |
|---|---|---|
| Monomer (b): methacrylonitrile | 50.0 | parts (80.3 mol %) |
| Other monomer: n-butyl acrylate | 10.0 | parts (8.4 mol %) |
| Colorant: Pigment Blue 15:3 | 6.5 | parts |

The above mixture was put into an attritor (manufactured by Nippon Coke & Engineering Co., Ltd.) and dispersed at 200 rpm for 2 h using zirconia beads having a diameter of 5 mm to obtain a raw material dispersion.

Meanwhile, 735.0 parts of ion-exchanged water and 16.0 parts of trisodium phosphate (dodecahydrate) were added to a container equipped with a high-speed stirring device Homomixer (manufactured by Primix Corporation) and a thermometer, and the temperature was raised to 60° C. while stirring the mixture at 12000 rpm. An aqueous calcium chloride solution in which 9.0 parts of calcium chloride (dihydrate) was dissolved in 65.0 parts of ion-exchanged water was added to the mixture, and the mixture was stirred at 12,000 rpm for 30 min while maintaining 60° C. The pH was adjusted to 6.0 by adding 10% hydrochloric acid to obtain an aqueous medium in which an inorganic dispersion stabilizer including hydroxyapatite was dispersed in water.

Subsequently, the raw material dispersion was transferred to a container equipped with a stirrer and a thermometer, and the temperature was raised to 60° C. while stirring at 100 rpm. The following materials:

| | | |
|---|---|---|
| Monomer (a): behenyl acrylate | 40.0 | parts (11.3 mol %) |
| Amorphous resin | 15.0 | parts |

were added and stirred at 100 rpm for 30 min while maintaining 60° C., then 5.0 parts of t-butyl peroxypivalate (Perbutyl PV, manufactured by NOF Corporation) was added as a polymerization initiator followed by stirring for 1 min. The mixture was then put into the aqueous medium that was stirred at 12,000 rpm with the high-speed stirring device. The stirring was continued at 12,000 rpm for 20 min with the above high-speed stirring device while maintaining 60° C. to obtain a granulated liquid.

The granulated liquid was transferred to a reaction vessel equipped with a reflux condenser, a stirrer, a thermometer, and a nitrogen introduction tube, and the temperature was raised to 70° C. while stirring at 150 rpm in a nitrogen atmosphere. A polymerization reaction was carried out at 150 rpm for 12 h while maintaining 70° C. to obtain a toner particle-dispersed solution.

The obtained toner particle-dispersed solution was cooled to 20° C. while stirring at 150 rpm, and then dilute hydrochloric acid was added until the pH became 1.5 while maintaining the stirring to dissolve the dispersion stabilizer. The solid amount was filtered off, thoroughly washed with ion-exchanged water, and then vacuum dried at 40° C. for 24 h to obtain toner particles 1.

A total of 2.0 parts of silica fine particles (hydrophobization treatment with hexamethyldisilazane, number average particle size of primary particles: 10 nm, BET specific surface area: 170 m²/g) was added as an external additive with respect to 100.0 parts of the obtained toner particles 1, and mixing was performed at 3000 rpm for 15 min using a Henchel mixer (manufactured by Nippon Coke & Engineering Co., Ltd.) to obtain a toner 1.

Further, in the production example of the toner 1, the same production was carried out under the conditions excluding the colorant and the amorphous resin to obtain a crystalline resin′ 1. The crystalline resin′ 1 had a weight average molecular weight of 42,000, an acid value of 0.0 mg KOH/g, and a melting point of 60° C. When the crystalline resin′ 1 was analyzed by NMR, the monomer unit derived from behenyl acrylate was included at 11.3 mol %, the monomer unit derived from methacrylonitrile was included at 80.3 mol %, and the monomer unit derived from n-butyl acrylate was included at 8.4 mol %. The physical property values of the crystalline resin′ 1 were taken as the physical property values of the crystalline resin used for the toner particle 1.

### Production Examples of Toner Particles 2 to 10 and 24 to 28, Crystalline Resins' 2 to 10 and 24 to 28, and Toners 2 to 10 and 24 to 28

Toner particles 2 to 10 and 24 to 28, crystalline resins' 2 to 10 and 24 to 28, and toners 2 to 10 and 24 to 28 were obtained in the same manner as in the production example of the toner 1, except that the type and addition amount of the monomers and the type and amount of the amorphous resin were changed as shown in Table 1. The physical property values of the crystalline resins' 2 to 10 and 24 to 28 were taken as the physical property values of the crystalline resins used for the toner particles 2 to 10 and 24 to 28.

### Production Examples of Toner Particle 16, Crystalline Resin′ 16 and Toner 16

The toner particle 16, crystalline resin′ 16, and toner 16 were obtained in the same manner as in the production example of toner 1 except that 50.0 parts of methacrylonitrile (monomer (b)) and 10.0 parts of n-butyl acrylate (other monomer) in the mixture in the production example of toner 1 were changed to 36.0 parts of vinyl acetate (monomer (c)) and 24.0 parts of methacrylonitrile (monomer (b)). The physical property values of the obtained crystalline resin′ 16 were taken as the physical property values of the crystalline resin used for the toner particles 16.

### Production Examples of Toner Particles 17 to 23 and 29 to 31, Crystalline Resins' 17 to 23 and 29 to 31, and Toners 17 to 23 and 29 to 31

The toner particles 17 to 23 and 29 to 31, crystalline resins' 17 to 23 and 29 to 31, and toners 17 to 23 and 29 to 31 were obtained in the same manner as in the production example of toner 16 except that 36.0 parts of vinyl acetate in the mixture of the production example of toner 16 was changed to the monomer (c) shown in Table 2, and 24.0 parts of methacrylonitrile in the mixture was changed to the monomer (b) shown in Table 2. The physical property values of the crystalline resins' 17 to 23 and 29 to 31 were taken as the physical property values of the crystalline resins used for the toner particles 17 to 23 and 29 to 31.

TABLE 1

| | Monomer (a) | | Monomer (b) | | Other monomers | | Amorphous resin | |
|---|---|---|---|---|---|---|---|---|
| | | Amount | | Amount | | Amount | | Amount |
| | Type | (parts) | Type | (parts) | Type | (parts) | Type | (parts) |
| Toner particle 1 | Behenyl | 40.0 | Methacrylonitrile | 50.0 | n-Butyl | 10.0 | Amorphous | 5.0 |
| | acrylate | | | | acrylate | | resin 1 | |
| Toner particle 2 | Behenyl | 40.0 | Methacrylonitrile | 45.0 | n-Butyl | 15.0 | Amorphous | 5.0 |
| | acrylate | | | | acrylate | | resin 1 | |
| Toner particle 3 | Behenyl | 40.0 | Methacrylonitrile | 40.0 | n-Butyl | 20.0 | Amorphous | 5.0 |
| | acrylate | | | | acrylate | | resin 1 | |
| Toner particle 4 | Behenyl | 40.0 | Methacrylonitrile | 55.0 | n-Butyl | 5.0 | Amorphous | 5.0 |
| | acrylate | | | | acrylate | | resin 1 | |
| Toner particle 5 | Behenyl | 60.0 | Methacrylonitrile | 33.0 | n-Butyl | 7.0 | Amorphous | 5.0 |
| | acrylate | | | | acrylate | | resin 1 | |
| Toner particle 6 | Behenyl | 30.0 | Methacrylonitrile | 58.0 | n-Butyl | 12.0 | Amorphous | 5.0 |
| | acrylate | | | | acrylate | | resin 1 | |
| Toner particle 7 | Behenyl | 40.0 | Methacrylonitrile | 30.0 | n-Butyl | 10.0 | Amorphous | 5.0 |
| | acrylate | | | | acrylate | | resin 1 | |
| | | | | | Methyl | 20.0 | | |
| | | | | | methacrylate | | | |
| Toner particle 8 | Behenyl | 40.0 | 2-Hydroxypropyl | 25.0 | Styrene | 35.0 | Amorphous | 5.0 |
| | acrylate | | methacrylate | | | | resin 1 | |
| Toner particle 9 | Behenyl | 40.0 | Methacrylonitrile | 50.0 | n-Butyl | 10.0 | Amorphous | 5.0 |
| | acrylate | | | | acrylate | | resin 2 | |
| Toner particle 10 | Behenyl | 40.0 | Methacrylonitrile | 50.0 | n-Butyl | 10.0 | Amorphous | 5.0 |
| | acrylate | | | | acrylate | | resin 3 | |
| Toner particle 24 | Behenyl | 40.0 | Acrylonitrile | 40.0 | Styrene | 20.0 | Amorphous | 5.0 |
| | acrylate | | | | | | resin 1 | |
| Toner particle 25 | Behenyl | 40.0 | Acrylonitrile | 20.0 | Styrene | 40.0 | Amorphous | 5.0 |
| | acrylate | | | | | | resin 1 | |
| Toner particle 26 | Behenyl | 40.0 | — | — | Styrene | 60.0 | Amorphous | 5.0 |
| | acrylate | | | | | | resin 1 | |
| Toner particle 27 | Behenyl | 65.0 | Methacrylonitrile | 29.0 | n-Butyl | 6.0 | Amorphous | 5.0 |
| | acrylate | | | | acrylate | | resin 1 | |
| Toner particle 28 | Behenyl | 28.0 | Methacrylonitrile | 60.0 | n-Butyl | 12.0 | Amorphous | 5.0 |
| | acrylate | | | | acrylate | | resin 1 | |

TABLE 2

| | Monomer (a) | | Monomer (c) | | Monomer (b) | | Other monomers | | Amorphous resin | |
|---|---|---|---|---|---|---|---|---|---|---|
| | | Amount | | Amount | | Amount | | Amount | | Amount |
| | Type | (parts) | Type | (parts) | Type | (parts) | Type | (parts) | Type | (parts) |
| Toner particle 16 | Behenyl | 40.0 | Vinyl | 36.0 | Methacrylonitrile | 24.0 | — | — | Amorphous | 5.0 |
| | acrylate | | acetate | | | | | | resin 1 | |
| Toner particle 17 | Behenyl | 40.0 | Vinyl | 30.0 | — | — | Styrene | 30.0 | Amorphous | 5.0 |
| | acrylate | | acetate | | | | | | resin 1 | |
| Toner particle 18 | Behenyl | 40.0 | Vinyl | 20.0 | Methacrylonitrile | 40.0 | — | — | Amorphous | 5.0 |
| | acrylate | | propionate | | | | | | resin 1 | |
| Toner particle 19 | Behenyl | 40.0 | Vinyl | 35.0 | Methacrylonitrile | 25.0 | — | — | Amorphous | 5.0 |
| | acrylate | | propionate | | | | | | resin 1 | |
| Toner particle 20 | Behenyl | 40.0 | Vinyl | 12.0 | Methacrylonitrile | 48.0 | — | — | Amorphous | 5.0 |
| | acrylate | | propionate | | | | | | resin 1 | |
| Toner particle 21 | Behenyl | 40.0 | Vinyl | 10.0 | Methacrylonitrile | 50.0 | — | — | Amorphous | 5.0 |
| | acrylate | | propionate | | | | | | resin 1 | |
| Toner particle 22 | Behenyl | 40.0 | Vinyl | 55.0 | Methacrylonitrile | 5.0 | — | — | Amorphous | 5.0 |
| | acrylate | | pivalate | | | | | | resin 1 | |
| Toner particle 23 | Behenyl | 40.0 | Vinyl | 55.0 | Methacrylonitrile | 5.0 | — | — | Amorphous | 5.0 |
| | acrylate | | benzoate | | | | | | resin 1 | |
| Toner particle 29 | Behenyl | 40.0 | Vinyl | 45.0 | — | — | Styrene | 15.0 | Amorphous | 5.0 |
| | acrylate | | acetate | | | | | | resin 1 | |
| Toner particle 30 | Behenyl | 60.0 | Vinyl | 30.0 | — | — | Styrene | 10.0 | Amorphous | 5.0 |
| | acrylate | | acetate | | | | | | resin 1 | |
| Toner particle 31 | Behenyl | 40.0 | Vinyl | 60.0 | — | — | — | — | Amorphous | 5.0 |
| | acrylate | | acetate | | | | | | resin 1 | |

### Production Example of Toner 11

| | | |
|---|---|---|
| Crystalline resin 1 | 95.0 | parts |
| Amorphous resin 4 | 5.0 | parts |
| C.I. Pigment Blue 15:3 | 6.5 | parts |
| Charge control agent (T-77: manufactured by | 2.0 | parts |
| Hodogaya Chemical Co., Ltd.) | | |

The above materials were premixed with an FM mixer (manufactured by Nippon Coke & Engineering Co., Ltd.) and then melt-kneaded with a twin-screw kneading extruder (PCM-30 type, manufactured by Ikegai Iron Works Co., Ltd.).

The obtained kneaded product was cooled, roughly pulverized with a hammer mill, and then pulverized with a mechanical pulverizer (T-250 manufactured by Turbo Industries, Ltd.), and the obtained finely pulverized powder classified with a multicomponent classifier using a Coanda effect to obtain toner particles 11.

External addition to the toner particles 11 was performed in the same manner as in Example 1 to obtain a toner 11.

### Production Examples of Toners 12 to 15 and 32

Toner particles 12 to 15 and 32 and toners 12 to 15 and 32 were obtained in the same manner as in the production example of toner 11, except that the type and addition amount of resin and the type and addition amount of wax were changed as shown in Table 3.

TABLE 3

| | Crystalline resin | | Amorphous resin | | Wax | |
|---|---|---|---|---|---|---|
| | | Amount | | Amount | | Amount |
| | Type | (parts) | Type | (parts) | Type | (parts) |
| Toner particle 11 | Crystalline | 95.0 | Amorphous | 5.0 | — | — |
| | resin 1 | | resin 4 | | | |
| Toner particle 12 | Crystalline | 75.0 | Amorphous | 25.0 | — | — |
| | resin 1 | | resin 4 | | | |
| Toner particle 13 | Crystalline | 60.0 | Amorphous | 40.0 | — | — |
| | resin 1 | | resin 4 | | | |
| Toner particle 14 | Crystalline | 75.0 | Amorphous | 25.0 | EXCEREX 30050 B | 10.0 |
| | resin 1 | | resin 4 | | (polyolefin wax) | |
| Toner particle 15 | Crystalline | 75.0 | Amorphous | 25.0 | HNP-9 | 10.0 |
| | resin 1 | | resin 4 | | (paraffin wax) | |
| Toner particle 32 | Crystalline | 75.0 | Amorphous | 25.0 | — | — |
| | resin 2 | | resin 4 | | | |

The physical properties of the obtained toners 1 to 32 were measured using the above-mentioned method. Tables 4 and 5 show the measurement results of the physical properties of the crystalline resin contained in each toner particle.

TABLE 4

| | | Composition and physical properties of crystalline resin | | | | | | | | |
|---|---|---|---|---|---|---|---|---|---|---|
| | | Glass transition | Monomer (a) | | | Monomer (b) | | | | |
| | | temperature | | | N(a) | | | N(b) | | SP(b) − |
| | | (° C.) | Type | SP(a) | (% by mass) | Type | SP(b) | (% by mass) | SP(A) | SP(a) |
| Toner particle 1 | Crystalline | 70 | Behenyl | 18.3 | 40 | Methacrylonitrile | 26.0 | 83 | 24.6 | 7.7 |
| | resin′ 1 | | acrylate | | | | | | | |
| Toner particle 2 | Crystalline | 60 | Behenyl | 18.3 | 40 | Methacrylonitrile | 26.0 | 75 | 24.3 | 7.7 |
| | resin′ 2 | | acrylate | | | | | | | |
| Toner particle 3 | Crystalline | 50 | Behenyl | 18.3 | 40 | Methacrylonitrile | 26.0 | 67 | 23.9 | 7.7 |
| | resin′ 3 | | acrylate | | | | | | | |
| Toner particle 4 | Crystalline | 95 | Behenyl | 18.3 | 40 | Methacrylonitrile | 26.0 | 92 | 24.9 | 7.7 |
| | resin′ 4 | | acrylate | | | | | | | |
| Toner particle 5 | Crystalline | 70 | Behenyl | 18.3 | 60 | Methacrylonitrile | 26.0 | 83 | 23.8 | 7.7 |
| | resin′ 5 | | acrylate | | | | | | | |
| Toner particle 6 | Crystalline | 70 | Behenyl | 18.3 | 30 | Methacrylonitrile | 26.0 | 83 | 24.8 | 7.7 |
| | resin′ 6 | | acrylate | | | | | | | |
| Toner particle 7 | Crystalline | 69 | Behenyl | 18.3 | 40 | Methacrylonitrile | 26.0 | 50 | 23.1 | 7.7 |
| | resin′ 7 | | acrylate | | | | | | | |
| Toner particle 8 | Crystalline | 68 | Behenyl | 18.3 | 40 | 2-Hydroxypropyl | 24.1 | 42 | 23.7 | 5.8 |
| | resin′ 8 | | acrylate | | | methacrylate | | | | |
| Toner particle 9 | Crystalline | 70 | Behenyl | 18.3 | 40 | Methacrylonitrile | 26.0 | 83 | 24.6 | 7.7 |
| | resin′ 9 | | acrylate | | | | | | | |
| Toner particle 10 | Crystalline | 70 | Behenyl | 18.3 | 40 | Methacrylonitrile | 26.0 | 83 | 24.6 | 7.7 |
| | resin′ 10 | | acrylate | | | | | | | |
| Toner particle 11 | Crystalline | 70 | Behenyl | 18.3 | 60 | Methacrylonitrile | 26.0 | 83 | 23.8 | 7.7 |
| | resin 1 | | acrylate | | | | | | | |
| Toner particle 12 | Crystalline | 70 | Behenyl | 18.3 | 60 | Methacrylonitrile | 26.0 | 83 | 23.8 | 7.7 |
| | resin 1 | | acrylate | | | | | | | |
| Toner particle 13 | Crystalline | 70 | Behenyl | 18.3 | 60 | Methacrylonitrile | 26.0 | 83 | 23.8 | 7.7 |
| | resin 1 | | acrylate | | | | | | | |
| Toner particle 14 | Crystalline | 70 | Behenyl | 18.3 | 60 | Methacrylonitrile | 26.0 | 83 | 23.8 | 7.7 |
| | resin 1 | | acrylate | | | | | | | |
| Toner particle 15 | Crystalline | 70 | Behenyl | 18.3 | 60 | Methacrylonitrile | 26.0 | 83 | 23.8 | 7.7 |
| | resin 1 | | acrylate | | | | | | | |
| Toner particle 24 | Crystalline | 110 | Behenyl | 18.3 | 40 | Acrylonitrile | 29.4 | 67 | 26.6 | 11.1 |
| | resin′ 24 | | acrylate | | | | | | | |
| Toner particle 25 | Crystalline | 107 | Behenyl | 18.3 | 40 | Acrylonitrile | 29.4 | 33 | 23.9 | 11.1 |
| | resin′ 25 | | acrylate | | | | | | | |
| Toner particle 26 | Crystalline | 100 | Behenyl | 18.3 | 40 | — | — | — | 19.8 | — |
| | resin′ 26 | | acrylate | | | | | | | |
| Toner particle 27 | Crystalline | 70 | Behenyl | 18.3 | 65 | Methacrylonitrile | 26.0 | 83 | 23.5 | 7.7 |
| | resin′ 27 | | acrylate | | | | | | | |
| Toner particle 28 | Crystalline | 70 | Behenyl | 18.3 | 28 | Methacrylonitrile | 26.0 | 83 | 24.9 | 7.7 |
| | resin′ 28 | | acrylate | | | | | | | |

| | | | | | |
|---|---|---|---|---|---|
| Toner particle 32 | Crystalline | Not observed | Crystalline polyester | 20.5 | — |
| | resin 2 | | | | |

TABLE 5

| | | Composition and physical properties of crystalline resin | | | | | | | | |
|---|---|---|---|---|---|---|---|---|---|---|
| | | Glass transition | Monomer (a) | | | | Monomer (c) | | | |
| | | temperature | | | Q | N(a) | | | Q | N(c) |
| | | (° C.) | Type | SP(a) | value | (% by mass) | Type | SP(c) | value | (% by mass) |
| Toner particle 16 | Crystalline | 60 | Behenyl | 18.3 | 0.25 | 40 | Vinyl | 21.6 | 0.026 | 60 |
| | resin′ 16 | | acrylate | | | | acetate | | | |
| Toner particle 17 | Crystalline | 60 | Behenyl | 18.3 | 0.25 | 40 | Vinyl | 21.6 | 0.026 | 50 |
| | resin′ 17 | | acrylate | | | | acetate | | | |
| Toner particle 18 | Crystalline | 70 | Behenyl | 18.3 | 0.25 | 40 | Vinyl | 20.9 | 0.027 | 33 |
| | resin′ 18 | | acrylate | | | | propionate | | | |
| Toner particle 19 | Crystalline | 55 | Behenyl | 18.3 | 0.25 | 40 | Vinyl | 20.9 | 0.027 | 58 |
| | resin′ 19 | | acrylate | | | | propionate | | | |
| Toner particle 20 | Crystalline | 90 | Behenyl | 18.3 | 0.25 | 40 | Vinyl | 20.9 | 0.027 | 20 |
| | resin′ 20 | | acrylate | | | | propionate | | | |
| Toner particle 21 | Crystalline | 95 | Behenyl | 18.3 | 0.25 | 40 | Vinyl | 20.9 | 0.027 | 17 |
| | resin′ 21 | | acrylate | | | | propionate | | | |
| Toner particle 22 | Crystalline | 85 | Behenyl | 18.3 | 0.25 | 40 | Vinyl | 19.2 | 0.037 | 92 |
| | resin′ 22 | | acrylate | | | | pivalate | | | |
| Toner particle 23 | Crystalline | 85 | Behenyl | 18.3 | 0.25 | 40 | Vinyl | 22.2 | 0.030 | 92 |
| | resin′ 23 | | acrylate | | | | benzoate | | | |
| Toner particle 29 | Crystalline | 45 | Behenyl | 18.3 | 0.25 | 40 | Vinyl | 21.6 | 0.026 | 75 |
| | resin′ 29 | | acrylate | | | | acetate | | | |
| Toner particle 30 | Crystalline | 45 | Behenyl | 18.3 | 0.25 | 60 | Vinyl | 21.6 | 0.026 | 75 |
| | resin′ 30 | | acrylate | | | | acetate | | | |
| Toner particle 31 | Crystalline | 30 | Behenyl | 18.3 | 0.25 | 40 | Vinyl | 21.6 | 0.026 | 100 |
| | resin′ 31 | | acrylate | | | | acetate | | | |

| | Composition and physical properties of crystalline resin | | | | | |
|---|---|---|---|---|---|---|
| | Monomer (b) | | | SP(b) − | SP(c) − | Q(a) − |
| | Type | SP(b) | SP(A) | SP(c) | SP(a) | Q(c) |
| Toner particle 16 | Methacrylonitrile | 26.0 | 23.0 | 4.4 | 3.3 | 0.224 |
| Toner particle 17 | — | — | 20.6 | — | 3.3 | 0.224 |
| Toner particle 18 | Methacrylonitrile | 26.0 | 23.9 | 5.1 | 2.6 | 0.223 |
| Toner particle 19 | Methacrylonitrile | 26.0 | 22.8 | 5.1 | 2.6 | 0.223 |
| Toner particle 20 | Methacrylonitrile | 26.0 | 24.5 | 5.1 | 2.6 | 0.223 |
| Toner particle 21 | Methacrylonitrile | 26.0 | 24.6 | 5.1 | 2.6 | 0.223 |
| Toner particle 22 | Methacrylonitrile | 26.0 | 19.8 | 6.8 | 0.9 | 0.213 |
| Toner particle 23 | Methacrylonitrile | 26.0 | 22.0 | 3.8 | 3.9 | 0.220 |
| Toner particle 29 | — | — | 20.9 | — | 3.3 | 0.224 |
| Toner particle 30 | — | — | 20.5 | — | 3.3 | 0.224 |
| Toner particle 31 | — | — | 21.2 | — | 3.3 | 0.224 |

Tables 6 and 7 show the measurement results of the physical properties of each toner particle.

TABLE 6

| | Physical properties of toner | | | | | |
|---|---|---|---|---|---|---|
| | | Tc | Tm | ΔH | Tm − Tc | \|SP(B) − |
| | G*(50)/G*(30) | (° C.) | (° C.) | (J/g) | (° C.) | SP(A)\| |
| Toner particle 1 | 0.70 | 55.5 | 60.3 | 42 | 4.8 | 2.3 |
| Toner particle 2 | 0.55 | 53.8 | 58.4 | 40 | 4.6 | 2.0 |
| Toner particle 3 | 0.30 | 52.4 | 56.9 | 39 | 4.5 | 1.6 |
| Toner particle 4 | 0.70 | 53.2 | 59.9 | 40 | 6.7 | 2.6 |
| Toner particle 5 | 0.82 | 57.7 | 62.0 | 60 | 4.3 | 1.5 |
| Toner particle 6 | 0.51 | 48.9 | 55.1 | 35 | 6.2 | 2.5 |
| Toner particle 7 | 0.45 | 51.1 | 56.3 | 40 | 5.2 | 0.8 |
| Toner particle 8 | 0.70 | 47.2 | 54.0 | 40 | 6.8 | 1.4 |
| Toner particle 9 | 0.70 | 54.1 | 60.3 | 42 | 6.0 | 3.0 |
| Toner particle 10 | 0.70 | 54.1 | 60.3 | 42 | 6.0 | 4.3 |
| Toner particle 11 | 0.63 | 56.6 | 60.9 | 58 | 4.3 | 1.5 |
| Toner particle 12 | 0.54 | 52.2 | 58.2 | 38 | 6.0 | 1.5 |
| Toner particle 13 | 0.40 | 51.6 | 57.8 | 35 | 6.2 | 1.5 |
| Toner particle 16 | 0.60 | 57.4 | 62.2 | 45 | 4.8 | 0.7 |
| Toner particle 17 | 0.31 | 44.0 | 51.0 | 35 | 7.0 | 1.7 |
| Toner particle 18 | 0.63 | 56.7 | 61.7 | 45 | 5.0 | 1.6 |
| Toner particle 19 | 0.45 | 57.6 | 62.0 | 43 | 4.4 | 0.5 |
| Toner particle 20 | 0.74 | 55.4 | 61.8 | 45 | 6.4 | 2.2 |
| Toner particle 21 | 0.74 | 55.6 | 62.4 | 45 | 6.8 | 2.3 |
| Toner particle 22 | 0.75 | 55.6 | 61.5 | 45 | 5.9 | 2.5 |
| Toner particle 23 | 0.75 | 56.2 | 62.2 | 45 | 6.0 | 0.3 |
| Toner particle 24 | 0.80 | 51.0 | 60.0 | 42 | 9.0 | 4.3 |
| Toner particle 25 | 0.80 | 45.0 | 54.5 | 37 | 9.5 | 1.6 |
| Toner particle 26 | 0.05 | 35.3 | 47.4 | 28 | 12.1 | 2.5 |
| Toner particle 27 | 0.79 | 56.2 | 60.2 | 65 | 4.0 | 1.2 |
| Toner particle 28 | 0.70 | 51.3 | 58.1 | 27 | 6.8 | 2.6 |
| Toner particle 29 | 0.20 | 46.0 | 52.8 | 38 | 6.8 | 1.4 |
| Toner particle 30 | 0.27 | 46.6 | 52.6 | 60 | 6.0 | 1.8 |
| Toner particle 31 | 0.11 | 52.9 | 58.4 | 40 | 5.5 | 1.1 |
| Toner particle 32 | 0.12 | 26.4 | 53.9 | 42 | 27.5 | 1.8 |

TABLE 7

| | Physical properties of toner | | | | | |
|---|---|---|---|---|---|---|
| | | Tc′ | Tm′ | ΔH′ | Tm′ − Tc′ | \|SP(B) − |
| | G*(50)/G*(30) | (° C.) | (° C.) | (J/g) | (° C.) | SP(A)\| |
| Toner particle 14 | 0.61 | 55.4 | 61.4 | 50 | 6.0 | 1.5 |
| Toner particle 15 | 0.61 | 55.4 | 61.3 | 54 | 5.9 | 1.5 |

The performance of the obtained toners 1 to 32 was evaluated according to the following methods. The results are shown in Table 8.

### Low-Temperature Fixability

A toner was extracted from a commercially available cyan cartridge, and 50 g of the toner to be evaluated was filled in the cartridge. The process cartridge filled with the toner to be evaluated was allowed to stand for 48 h in a normal temperature and normal humidity environment (temperature 23° C., relative humidity 50%).

The process cartridge was mounted on a Canon laser beam printer LBP-7700C modified so that as to operate even if the fixing device was removed, and using this, an unfixed image of an image pattern in which a 10 mm×10 mm square image was evenly arranged at 9 points on the entire transfer paper was outputted. The toner laid-on level on the transfer paper was 0.80 mg/cm², and Fox River Bond (90 g/m²) was used as the transfer paper.

The outputted unfixed image was fixed using an external fixing device. A device obtained by removing a fixing device from LBP-7700C and making it operable even without the laser beam printer was used as the external fixing device. The process speed of the external fixing device was set to 330 mm/sec, the initial fixing temperature was set to 100° C., the set temperature was gradually raised by 5° C., and the unfixed image was fixed at each temperature.

The image fixed at each fixing temperature was rubbed back and forth 5 times with Sylbon paper (manufactured by Ozu Corporation: DUSPER K-3) under a load of 4.9 kPa (50 g/cm²). The image density before and after rubbing was measured with a Macbeth reflection densitometer (manufactured by Macbeth), the temperature at which the image density reduction rate before and after the rubbing became 20% or less was set as the fixing start temperature, and the low-temperature fixability was evaluated according to the following criteria.

A: Fixing start temperature is lower than 110° C.
B: Fixing start temperature is 110° C. or higher and lower than 120° C.
C: Fixing start temperature is 120° C. or higher and lower than 130° C.
D: Fixing start temperature is 130° C. or higher and lower than 140° C.
E: Fixing start temperature is 140° C. or higher and less than 150° C.
F: Fixing start temperature is 150° C. or higher

Heat Resistance of Image

An unfixed image of 6.0 cm in length×5.0 cm in width was outputted on the transfer paper. The toner laid-on level on the transfer paper was 0.80 mg/cm², and Fox River Bond (90 g/m²) was used as the transfer paper. The following evaluation was performed on an image paper on which the unfixed image was fixed at a temperature 20° C. higher than the fixing start temperature of each toner.

The fixed image paper was placed on 100 sheets of unused paper (Fox River Bond (90 g/m²)) with the image portion facing downward, and 2500 sheets of the same type of unused paper was further placed on the fixed image paper thereby sandwiching the fixed image paper. The stack was allowed to stand for 24 h in a thermostat adjusted to 55° C., and was then taken out from the thermostat. The reflectance of the portion, of the unused paper that was in contact with the fixed image paper, that was in contact with the image portion was measured. A color transfer of the image was measured by subtracting the reflectance of the portion of the unused paper that was not in contact with the image portion from the obtained reflectance. The heat resistance of the image was evaluated from the reflectance after subtraction according to the following criteria. The reflectance was measured with TC-6DS (manufactured by Tokyo Denshoku Co., Ltd.).

A: Reflectance after deduction is less than 2.0%
B: Reflectance after subtraction is 2.0% or more and less than 3.0%
C: Reflectance after subtraction is 3.0% or more and less than 5.0%
D: Reflectance after subtraction is 5.0% or more and less than 8.0%
E: Reflectance after subtraction is 8.0% or more and less than 10.0%
F: Reflectance after subtraction is 10.0% or more

Scratch Resistance of Images

An unfixed image of 6.0 cm in length×5.0 cm in width was outputted on a transfer paper. The amount of toner on the transfer paper was 0.80 mg/cm², and Fox River Bond (90 g/m²) was used as the transfer paper. The following evaluation was performed on an image paper on which the unfixed image was fixed at a temperature 20° C. higher than the fixing start temperature of each toner.

The scratch resistance of the fixed image was evaluated on the basis of the image density reduction rate before and after rubbing the fixed image with Sylbon paper (manufactured by Ozu Corporation: DUSPER K-3) under a load of 4.9 kPa (50 g/cm²) for 3 min at a speed of 1 reciprocation per second. The image density reduction rate was measured with a Macbeth reflection densitometer (manufactured by Macbeth).

The evaluation criteria for scratch resistance of fixed images are as follows.

A: Density reduction rate is less than 3.0%
B: Density reduction rate is 3.0% or more and less than 5.0%
C: Density reduction rate is 5.0% or more and less than 8.0%
D: Density reduction rate is 8.0% or more and less than 10.0%
E: Density reduction rate is 10.0% or more and less than 15.0%
F: Density reduction rate is 15.0% or more

TABLE 8

| | | Low-temperature fixability | | Heat resistance of image | | Scratch resistance of image | |
|---|---|---|---|---|---|---|---|
| | | Fixing start temperature | | Reflectance after subtracting | | Density reduction rate | |
| | | (° C.) | Rank | (%) | Rank | (%) | Rank |
| Example 1 | Toner 1 | 105 | A | 1.7 | A | 2.8 | A |
| Example 2 | Toner 2 | 100 | A | 2.5 | B | 2.3 | A |
| Example 3 | Toner 3 | 100 | A | 3.3 | C | 1.9 | A |
| Example 4 | Toner 4 | 115 | B | 4.5 | C | 3.1 | B |
| Example 5 | Toner 5 | 100 | A | 1.5 | A | 5.8 | C |
| Example 6 | Toner 6 | 125 | C | 2.2 | B | 1.8 | A |
| Example 7 | Toner 7 | 105 | A | 4.0 | C | 2.5 | A |
| Example 8 | Toner 8 | 105 | A | 5.5 | D | 2.3 | A |
| Example 9 | Toner 9 | 110 | B | 2.8 | B | 7.7 | C |
| Example 10 | Toner 10 | 115 | B | 3.1 | C | 8.5 | D |
| Example 11 | Toner 11 | 100 | A | 1.9 | A | 5.9 | C |
| Example 12 | Toner 12 | 110 | B | 2.2 | B | 2.8 | A |
| Example 13 | Toner 13 | 125 | C | 2.4 | B | 2.2 | A |
| Example 14 | Toner 14 | 100 | A | 1.7 | A | 2.6 | A |
| Example 15 | Toner 15 | 100 | A | 1.2 | A | 2.6 | A |
| Example 16 | Toner 16 | 105 | A | 1.8 | A | 2.0 | A |
| Example 17 | Toner 17 | 100 | A | 7.6 | D | 1.2 | A |
| Example 18 | Toner 18 | 105 | A | 1.6 | A | 2.4 | A |
| Example 19 | Toner 19 | 105 | A | 2.0 | B | 1.9 | A |
| Example 20 | Toner 20 | 110 | B | 2.9 | B | 2.7 | A |
| Example 21 | Toner 21 | 115 | B | 4.2 | C | 2.9 | A |
| Example 22 | Toner 22 | 110 | B | 1.7 | A | 2.2 | A |
| Example 23 | Toner 23 | 110 | B | 1.7 | A | 6.5 | C |
| Comparative | Toner 24 | 125 | C | 8.2 | E | 8.1 | D |
| Example 1 | | | | | | | |
| Comparative | Toner 25 | 115 | B | 9.5 | E | 2.3 | A |
| Example 2 | | | | | | | |
| Comparative | Toner 26 | 120 | C | 12.0 | F | 2.6 | A |
| Example 3 | | | | | | | |
| Comparative | Toner 27 | 100 | A | 1.5 | A | 15.3 | F |
| Example 4 | | | | | | | |
| Comparative | Toner 28 | 140 | E | 3.5 | C | 1.0 | A |
| Example 5 | | | | | | | |
| Comparative | Toner 29 | 110 | B | 13.5 | F | 1.6 | A |
| Example 6 | | | | | | | |
| Comparative | Toner 30 | 100 | A | 8.5 | E | 1.5 | A |
| Example 7 | | | | | | | |
| Comparative | Toner 31 | 110 | B | 14.2 | F | 1.4 | A |
| Example 8 | | | | | | | |
| Comparative | Toner 32 | 115 | B | 18.3 | F | 1.9 | A |
| Example 9 | | | | | | | |

While the present invention has been described with reference to exemplary embodiments, itis to beunderstood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-224161, filed Dec. 12, 2019 which is hereby incorporated by reference herein in its entirety.

What is claimed is:

1. A toner comprising a toner particle including a crystalline resin, wherein where a complex modulus of elasticity at 30° C. is denoted by G*(30) and a complex modulus of elasticity at 50° C. is denoted by G*(50) in dynamic viscoelasticity measurement of the toner, following is satisfied:
1.00≥G*(50)/G*(30)≥0.30,
and where
a peak temperature of an exothermic peak derived from the crystalline resin in a temperature lowering process after a temperature is raised to 150° C., is denoted by Tc (° C.),
a peak temperature of an endothermic peak derived from the crystalline resin in a temperature raising process after the temperature lowering process, is denoted by Tm (° C.), and
an endothermic quantity is denoted by ΔH (J/g) in differential scanning calorimetry of the toner,
Tm is 50.0 to 80.0° C.,
ΔH is 35 to 60 J/g, and
Tm− Tc is 0.0 to 7.0° C.

2. A toner comprising a toner particle including a crystalline resin and a wax, wherein
where a complex modulus of elasticity at 30° C. is denoted by G*(30) and a complex modulus of elasticity at 50° C. is denoted by G*(50) in dynamic viscoelasticity measurement of the toner, following is satisfied:
1.00≥G*(50)/G*(30)≥0.30,
an amount of the wax in the toner particle is 1 to 20 parts by mass with respect to 100 parts by mass of the crystalline resin; and
and where
a peak temperature of a maximum exothermic peak in a temperature lowering process after a temperature is raised to 150° C., is denoted by Tc′ (° C.),
a peak temperature of a maximum endothermic peak in a temperature raising process after the temperature lowering process, is denoted by Tm′ (° C.), and
an endothermic quantity is denoted by ΔH′ (J/g) in differential scanning calorimetry of the toner,
Tm′ is 50.0 to 80.0° C.,
ΔH′ is 35 to 60 J/g, and
Tm′−Tc′ is 0.0 to 7.0° C.

3. The toner according to claim 1, wherein
the crystalline resin comprises a monomer unit derived from a monomer (a),
the monomer (a) is a (meth)acrylate having a chain hydrocarbon group having from 18 to 36 carbon atoms, and
a content ratio N(a) of the monomer unit derived from the monomer (a) in the crystalline resin is 30 to 60% by mass.

4. The toner according to claim 1, wherein an amount of the crystalline resin in the toner particle is 60 to 100% by mass.

5. The toner according to claim 1, wherein a glass transition temperature (° C.) of the crystalline resin is 50 to 90° C.

6. The toner according to claim 1, wherein
the toner particle further includes an amorphous resin, and
where an SP value of the amorphous resin is denoted by SP(B) (J/cm³)^{0.5} and an SP value of the crystalline resin is denoted by SP(A) (J/cm³)^{0.5}, following is satisfied:
3.0≥|SP(B)−SP(A)|≥0.0.

7. The toner according to claim 3, wherein
the crystalline resin further comprises a monomer unit derived from a monomer (b),
where an SP value of the monomer unit derived from the monomer (a) is denoted by SP(a) (J/cm³)^{0.5}, and an SP value of the monomer unit derived from the monomer (b) is denoted by SP(b) (J/cm³)^{0.5}, following is satisfied:
SP(b)−SP(a)≥4.0,
and
a content ratio N(b) of the monomer unit derived from the monomer (b) in all the monomer units other than the monomer unit derived from the monomer (a) in the crystalline resin is 50 to 100% by mass.

8. The toner according to claim 3, wherein
the crystalline resin further comprises a monomer unit derived from a monomer (c), and
a Q value of the monomer (c) is smaller than a Q value of the monomer (a).

9. The toner according to claim 8, wherein where the Q value of the monomer (c) is denoted by Q(c) and the Q value of the monomer (a) is denoted by Q(a), Q(a)-Q(c) is 0.210 to 0.230.

10. The toner according to claim 8, wherein a content ratio N(c) of the monomer unit derived from the monomer (c) in all the monomer units other than the monomer unit derived from the monomer (a) in the crystalline resin is 20 to 100% by mass.

11. The toner according to claim 8, wherein
the crystalline resin further comprises a monomer unit derived from a monomer (b), and
where an SP value of the monomer unit derived from the monomer (c) is denoted by SP(c) (J/cm³)^{0.5}, an SP value of the monomer unit derived from the monomer (b) is denoted by SP(b) (J/cm³)^{0.5}, and an SP value of the monomer unit derived from the monomer (a) is denoted by SP(a) (J/cm³)^{0.5}, followings are satisfied:
SP(b)−SP(c)≥3.0,
SP(c)−SP(a)≤4.0.

12. The toner according to claim 8, wherein the monomer (c) has a structure represented by a following formula (1):
R—COO—CH═CH₂ (1)
where, R represents a phenyl group or an alkyl group having 1 to 12 carbon atoms.

13. The toner according to claim 8, wherein the monomer (c) is at least one selected from the group consisting of vinyl benzoate, vinyl pivalate and vinyl propionate.
